(19) United States
(12) Patent Application Publication
(10) Pub. No.: US 2004/0035623 A1
(43) Pub. Date: Feb. 26, 2004

(54) Frame configuration for a three-wheel vehicle

(76) Inventors: Berthold Fecteau, Richmond (CA); Bruno Girouard, Montreal (CA); Alain Massicotte, Orford (CA); Daniel Mercier, Longueuil (CA); Anne-Marie Dion, Granby (CA); Jerome Wubbolts, Orford (CA)

Correspondence Address: PILLSBURY WINTHROP, LLP, P.O. BOX 10500, MCLEAN, VA, 22102, US

(21) Appl. No.: 10/371,224

(22) Filed: Feb. 24, 2003

Related U.S. Application Data
(60) Provisional application No. 60/358,390, filed on Feb. 22, 2002.
(60) Provisional application No. 60/358,400, filed on Feb. 22, 2002.

(51) Int. Cl. B62D 61/06

(52) U.S. Cl. 180/210

(57) ABSTRACT

A three-wheel vehicle has two forward steered wheels, one rear powered wheel, and a straddle-type seat disposed between the forward and rear wheels. The vehicle's frame has interconnected tubular members that create a strong, light, rigid frame that can accommodate a high performance engine. The frame's components include upper spars, lower spars, rear suspension plates, a front suspension sub-frame, rear suspension braces, a pyramid-shaped upper support assembly, various cross braces, and a rear sub-frame, among other components. Two or more of the frame components may be integrally formed and removably connected to the other frame components to simplify assembly, maintenance, and replacement. The frame is designed to lower the center of gravity of the vehicle and rider so as to stabilize the vehicle. The front suspension sub-frame includes a longitudinal air passage that directs air into the engine compartment and around an oil cooler.

### CROSS-REFERENCE

This application is related to and claims the benefit of priority to U.S. Provisional Patent Application No. 60/358,390, titled “FRAME CONFIGURATION FOR A THREE-WHEEL VEHICLE,” and U.S. Provisional Patent Application Serial No. 60/358,400, both of which were filed on Feb. 22, 2002. The disclosures of these related applications are specifically incorporated herein by reference.

This application is also related but does not claim priority to the following U.S. provisional applications that were filed on Feb. 22, 2002: No. 60/358,362, No. 60/358,394; No. 60/358,395; No. 60/358,397; No. 60/358,398; No. 60/358,436; and, No. 60/358,439 and any non-provisional patent applications claiming priority to the same. This application is also related but does not claim priority to U.S. provisional application No. 60/358,737, which was filed on Feb. 25, 2002, and U.S. provisional application No. 60/418,355, which was filed on Oct. 16, 2002, and any non-provisional patent applications claiming priority to the same. The entirety of the subject matter of these applications is incorporated by reference herein.

This application is also related to but does not claim priority to U.S. Design Application 29/155,964 filed on Feb. 22, 2002, and U.S. Design Application 29/156,028 filed on Feb. 23, 2002. This application is also related to but does not claim priority to U.S. patent application Ser. No. 10/346,188 and U.S. patent application Ser. No. 10/346,189 which were filed on Jan. 17, 2003. The entirety of the subject matter of these applications is incorporated by reference herein.

### BACKGROUND OF THE INVENTION

1. Field of the Invention

The present invention relates generally to frame configurations for three-wheel vehicles.

2. Description of the Related Art

The frames of conventional three-wheel vehicles are typically based on two-wheel motorcycle frames that have been modified to accommodate two front wheels instead of one.

For example, U.S. Pat. No. 4,787,470 discloses a three-wheel vehicle with two front wheels and a sole rear wheel having a body formed by a motorcycle frame. The frame is adapted to support two front fenders, one rear fender, and a saddle-type seat. In this vehicle, the center of gravity of the rider and the vehicle are located a considerably large distance above the ground, because the vehicle is based on a motorcycle frame. Further, because the vehicle described in the '470 patent is based on a two-wheel motorcycle, its frame is not designed to accommodate the torsional stresses that result from the addition of a third wheel (second front wheel). Consequently, the vehicle body is not expected to exhibit characteristics of stability and maneuverability when subjected to the types of high loads, bending moments, and stresses that would be exerted on the vehicle during operation.

The frames of conventional three-wheeled vehicles also are based on snowmobile chassis, which have been modified to support two wheels at the front end and one wheel at the rear end.

For example, U.S. Pat. No. 4,662,468 discloses a three-wheel vehicle with two front wheels and a sole rear wheel. The three-wheel vehicle of the '468 patent uses a conventional snowmobile chassis that has been modified to attach two driving wheels at its front end in the place of the snowmobile's snow skis. The rear wheel is positioned beneath the seat on the snowmobile frame.

Similarly, U.S. Pat. No. 5,564,517 discloses a snowmobile conversion frame kit. The converted snowmobile includes a frame having two wheels with a steering assembly in the front and a rear wheel with a swing arm in the rear.

The vehicles described in the '468 and '517 patents utilize conventional snowmobile chassis. Conventional snowmobile chassis, which include sheet metal tunnels, offer less rigidity and structural strength than are required for use in three-wheel vehicles, especially those designed for road use.

The prior art is devoid of any disclosure for a frame of a three-wheeled vehicle specifically designed as a three-wheeled vehicle for road use.

The adapted motorcycle and snowmobile frames, while they are believed to be usable for a three-wheeled vehicle, are not designed specifically to react to the types of torsional and binding stresses that are expected to be encountered by a three-wheeled vehicle during use.

One vehicle frame that was specifically developed for a three-wheeled vehicle is the frame incorporated into certain all terrain vehicles (or “ATVs”) that were commercialized in the early to mid 1980's. That ATV included a single, front, steerable wheel and two, powered, rear wheels.

While the frame for that ATV was specifically designed for a three-wheeled vehicle, the frame (and vehicle) did not address design parameters that arise when designing a vehicle for road use. First, being an ATV, the vehicle was specifically designed for off-road use. As a result, the vehicle was not constructed to handle the stresses encountered at road speeds. Second, because the vehicle included a single front balloon tire and two rear balloon tires, the vehicle had a relatively high center of gravity. As a result, the vehicle tended to be unstable at higher speeds. Third, in part because speed was not desired for the prior art three-wheeled ATV, the vehicle's engine provided an output power of only about 35 horsepower. The frame was designed to accommodate this low output and as a result, could not be adapted readily for road use.

Another vehicle frame specifically developed for a three-wheeled vehicle is the frame incorporated into a motorcycle with a side car. These frames are designed around a standard motorcycle frame with a wheel positioned at a point offset from the motorcycle frame.

Unlike the ATV example, a frame for a motorcycle with a side car is adapted for road use. Also, because it is designed for road use, the engines of such motorcycles typically produce a greater output power than the engines incorporated into the prior art ATV.

As would be appreciated by those skilled in the art, a motorcycle with a side car would have a relatively high center of gravity, a center of gravity akin to that found on a motorcycle. As a result, motorcycles with side cars suffer from the same instability problem as motorcycles adapted to include two front wheels. These motorcycles, accordingly, tend to be very unstable when making turns at high speeds.

In summary, a need has developed for a three-wheel vehicle that resolves these deficiencies.

### SUMMARY OF THE INVENTION

The present invention recognizes and solves one or more of the problems associated with conventional three-wheel vehicles by providing a vehicle frame that is specifically designed to be used as a three-wheel vehicle.

Accordingly, one aspect of embodiments of the present invention provides a three-wheel, straddle-type vehicle having two front wheels and one rear wheel.

An alternative aspect of embodiments of the present invention provides a three-wheel, straddle-type vehicle having a low center of gravity compared to conventional three-wheel vehicles.

An additional alternative aspect of embodiments of the present invention provides a three-wheel, straddle-type vehicle having improved maneuverability and control by comparison with conventional three-wheel vehicles.

A further alternative aspect of embodiments of the present invention provides a three-wheel, straddle-type vehicle designed for road use.

A further alternative aspect of embodiments of the present invention provides a strong frame assembly for a three-wheel vehicle.

A further alternative aspect of embodiments of the present invention provides a light, rigid frame assembly for a three-wheel vehicle.

A further alternative aspect of embodiments of the present invention provides a three-wheel vehicle frame assembly that includes modular components that are easily assembled, maintained, and/or replaced. A plurality of frame components are integrally formed to reduce the number of removably connected parts that must be assembled or disassembled to manufacture, maintain, and repair the vehicle.

A further alternative aspect of one or more embodiments of the present invention provides a three-wheel vehicle that includes a frame assembly. The frame assembly includes left and right laterally spaced rear suspension plates, left and right laterally spaced upper spars extending forwardly and upwardly from the left and right rear suspension plates, respectively, left and right lower spars extending forwardly from the left and right rear suspension plates, respectively, and a front suspension sub-frame with a rearward portion that connects to forward ends of the lower spars. The vehicle also includes an engine supported by the frame assembly, a pair of front wheels supported by the front suspension sub-frame, a single rear wheel supported by the frame assembly, the rear wheel being operatively connected to the engine such that the engine drives the rear wheel, and a straddle seat supported by the frame disposed between the front wheels and the rear wheel.

According to one or more of these embodiments, the front suspension sub-frame has left and right upwardly extending portions that are connected to forward ends of the left and right upper spars, respectively.

According to one or more of these embodiments, the frame assembly further includes a lower spar bracket connected to the forward ends of the lower spars and to the front suspension sub-frame. The forward ends of the lower spars connect together via their mutual connection to the lower spar bracket. The lower spar bracket and the lower spars may be integrally formed and are removably connected to the front suspension sub-frame and the rear suspension plates. The lower spar bracket and the lower spars may be formed by a bent sheet of metal.

According to one or more of these embodiments, the frame assembly further includes an engine cradle plate connecting the lower spars to the front suspension sub-frame. The engine cradle plate extends laterally and vertically and includes at least one bend along a laterally-oriented fold line. The frame assembly may further include left and right laterally spaced forward engine anchors connected to the engine cradle plate. The engine is mounted to the left and right laterally spaced forward engine anchors.

According to one or more of these embodiments, the lower spars extend laterally inwardly toward each other as they progress forwardly. The frame assembly may also include a laterally-extending lower rear engine cross brace connected between forward lower portions of the rear suspension plates such that the lower rear engine cross brace and the lower spars generally form a triangle when viewed from above. The frame assembly may further include a lower rear engine anchor attached to the lower rear engine cross brace. The engine is mounted to the lower rear engine anchor. The frame assembly may further include left and right laterally spaced lower rear engine anchors attached to the lower rear engine cross brace and mounted to the engine.

According to one or more of these embodiments, the rearward ends of the left and right lower spars are removably connected to the left and right rear suspension plates, respectively. The forward ends of the lower spars are removably connected to the front suspension sub-frame. The left and right lower spars, when removed from the frame assembly, enable access to the engine.

According to one or more of these embodiments, the frame assembly further includes left and right rear suspension braces connected to upper rearward portions of the left and right rear suspension plates, respectively. The left and right rear suspension braces, respectively, may be integrally formed with the left and right rear suspension plates, respectively.

According to a further aspect of one or more of these embodiments, the front suspension sub-frame has left and right upwardly extending portions. The frame assembly further includes a pyramid-shaped upper structural support assembly, which has a left upper column rear member extending forwardly and upwardly from a rearward portion of the left suspension brace to an apex, a right upper column rear member extending forwardly and upwardly from a rearward portion of the right suspension brace to the apex, a left upper column front member extending upwardly and rearwardly from the left upwardly extending portion of the front suspension sub-frame to the apex, and a right upper column front member extending upwardly and rearwardly from the right upwardly extending portion of the front suspension sub-frame to the apex.

The pyramid-shaped upper structural support assembly may also include a steering column bracket connected to upper ends of the front and rear left and right braces. The steering column bracket defines the apex.

According to a further aspect of one or more of these embodiments, the rear suspension braces extend upwardly and rearwardly from the rear suspension plates. The frame assembly may further include a left tank support member connected to the left rear suspension plate, a right tank support member connected to the right rear suspension plate, and a rear suspension cross brace connected between rearward portions of the left and right tank support members. The left and right tank support members, respectively, may be integrally formed with the left and right rear suspension plates, respectively. The left and right rear suspension braces, respectively, may be integrally formed with the left and right rear suspension plates, respectively. The frame assembly may further include a generally U-shaped rear sub-frame having ends connected to the rearward portions of the left and right suspension braces.

According to a further aspect of one or more of these embodiments, the rear sub-frame includes left and right portions. The left portion of the rear sub-frame, the left rear suspension brace, and the left rear suspension plate are integrally formed. The right portion of the rear sub-frame, the right rear suspension brace, and the right rear suspension plate are integrally formed.

According to a further aspect of one or more of these embodiments, the frame assembly further includes a left tank support member connected to the left rear suspension plate, a right tank support member connected to the right rear suspension plate, a left rear sub-frame brace connected between a rear end of the left tank support member and an intermediate portion of the rear sub-frame, and a right rear sub-frame brace connected between a rear end of the right tank support member and an intermediate portion of the rear sub-frame. The rear sub-frame braces, the tank support members, and the rear sub-frame generally form triangles when viewed from the side.

According to a further aspect of one or more of these embodiments, forward portions of the left and right tank support members are connected indirectly to upper forward portions of the left and right rear suspension plates, respectively, by way of a connection between the forward portions of the left and right tank support members to rearward portions of the left and right upper spars, respectively.

According to a further aspect of one or more of these embodiments, the vehicle also includes an upper rear engine support cross brace connected between forward upper portions of the left and right rear suspension plates. The upper rear engine support cross brace may connect indirectly to upper forward portions of the left and right rear suspension plates, respectively, by way of a connection between the upper rear engine support cross brace to rearward portions of the left and right upper spars, respectively. The frame assembly may further include left and right laterally-spaced upper rear engine anchors connected to the upper rear cross brace.

According to a further aspect of one or more of these embodiments, the frame assembly further includes an upper rear engine support cross brace connected between forward upper portions of the left and right rear suspension plates, left and right laterally-spaced upper rear engine anchors connected to the upper rear cross brace and to the engine, and left and right laterally spaced forward engine anchors connected to the front suspension sub-frame and the engine. The engine adds rigidity to the frame assembly by way of its simultaneous connection to the upper rear engine support cross brace, the front suspension sub-frame, and the lower rear engine cross brace.

According to a further aspect of one or more of these embodiments, the left and right upper spars, respectively, are integrally formed with the left and right rear suspension plates, respectively. The frame assembly may also include a rear suspension swing arm pivotally connected to the left and right rear suspension plates and supporting the rear wheel.

According to a further aspect of one or more of these embodiments, the front suspension sub-frame includes left and right portions that are removably connected together. The left and right upper spars removably connect to the left and right portions, respectively, of the front suspension sub-frame. The left front suspension sub-frame portion and the left lower spar are integrally formed. The right front suspension sub-frame portion and the right lower spar are integrally formed.

According to a further aspect of one or more of these embodiments, the vehicle also includes a handlebar and a progressive steering system operatively connecting the handlebar to the front wheels to steer the vehicle. A steering angle of the front wheels may increase progressively more and more per degree of handlebar rotation as the front wheels approach a maximum steering angle. Preferably, the handlebar cannot pivot more than 30 degrees to either side of its straight forward position, while the front wheels can pivot more than 40 degrees to either side of their straight forward position.

A further alternative aspect of one or more embodiments of the present invention provides a three-wheel vehicle that includes a frame assembly. The frame assembly includes left and right main frame members. Each frame member has a rear suspension plate portion, and a longitudinally-elongated upper spar portion formed integrally with the rear suspension plate portion and extending forwardly and upwardly from the rear suspension plate portion. The frame assembly also includes left and right lower frame members, each of which includes a longitudinally elongated lower spar portion. Rearward ends of the left and right lower frame members removably connect to the left and right rear suspension plate portions of the left and right main frame members, respectively. The frame assembly also includes left and right front suspension sub-frame portions connected to the left and right upper spar portions, respectively, and connected to the left and right lower spar portions, respectively. The vehicle further includes an engine supported by the frame assembly and disposed between the upper and lower spar portions as viewed from the side, a pair of front wheels supported by the front suspension sub-frame portions, a single rear wheel supported by the left and right rear suspension plate portions, the rear wheel being operatively connected to the engine such that the engine drives the rear wheel, and a straddle seat supported by the frame disposed between the front wheels and the rear wheel.

According to a further aspect of one or more of these embodiments, the left and right front suspension sub-frame portions, respectively, are integrally formed with the left and right lower frame members, respectively. The removable connections between the left and right front suspension sub-frame portions, respectively, and the left and right upper spar portions, respectively, may include bolts, and the removable connection between the left and right lower frame members, respectively, and the left and right rear suspension plate portions, respectively, may also include bolts.

According to a further aspect of one or more of these embodiments, the front suspension sub-frame has left and right upwardly extending portions that are connected to forward ends of the left and right upper spar portions, respectively.

According to a further aspect of one or more of these embodiments, the vehicle also includes a steering shaft pivotally connected to at least one of the main frame members and at least one of the front suspension sub-frame portions, and a handlebar connected to the steering shaft. The steering shaft operatively connects to the front wheels such that pivotal movement of the steering shaft steers the front wheels.

According to one or more embodiments of the present invention, one or more components of the vehicle (e.g., lower spars, lower rear engine cross brace, left and right front and upper column rear members, rear sub-frame, rear sub-frame braces, upper rear engine support cross brace, etc.) are tubular members.

Additional and/or alternative objects, features, aspects, and advantages of the embodiments of the present invention will become apparent from the following description, the accompanying drawings, and the appended claims.

### BRIEF DESCRIPTION OF THE DRAWINGS

For a better understanding of the present invention as well as other objects and further features thereof, reference is made to the following description which is to be used in conjunction with the accompanying drawings, where:

FIG. 1 is front view of a three-wheel vehicle according to one embodiment of the present invention;

FIG. 2 is a right side view thereof;

FIG. 3 is a top view thereof;

FIG. 4 is a partial left side view of the frame assembly, engine, and rear tire of the vehicle illustrated in FIGS. 1-3;

FIG. 5 is a perspective view of one embodiment of the frame assembly of the three-wheel vehicle of FIG. 1, as viewed from the rear left side;

FIG. 6 is a perspective view thereof, as viewed from the forward left side;

FIG. 7 is a left side view thereof;

FIG. 8 is a top view thereof;

FIG. 9 is a rear view thereof;

FIG. 10 is a partial perspective view of one embodiment of the front suspension system of the vehicle illustrated in FIG. 1;

FIG. 11 is a partial side view of the seat and frame assembly of FIG. 5 according to an embodiment of the present invention;

FIG. 12 is a partial perspective view of a rear suspension cross brace of the frame assembly of FIG. 5;

FIG. 13 is a partial perspective view of the frame assembly of FIG. 5 and fairing according to an embodiment of the present invention;

FIG. 14 is a partial perspective view of the front suspension and steering systems according to an embodiment of the present invention;

FIG. 15 is a partial exploded view of a progressive steering system according to alternative embodiments of the present invention;

FIG. 16 is a side view of a main frame member according to an alternative embodiment of the present invention;

FIG. 17 is a side view of a main frame member according to an additional alternative embodiment of the present invention;

FIG. 18 is a side view of a frame assembly according to a further alternative embodiments of the present invention;

FIG. 19 is a cross-sectional view of a tubular member according to one embodiment of the present invention;

FIG. 20 is a cross-sectional view of a tubular member according to an alternative embodiment of the present invention;

FIG. 21 is a cross-sectional view of a tubular member according to an additional alternative embodiment of the present invention;

FIG. 22 is a cross-sectional view of a tubular member according to a further alternative embodiment of the present invention;

FIG. 23 is a cross-sectional view of a tubular member according to yet a further alternative embodiment of the present invention;

FIG. 24 is a side view of a conventional motorcycle that has been converted into a three-wheel vehicle;

FIG. 25 is a partial side view of the conventional three-wheel vehicle of FIG. 24;

FIG. 26(A) is a cross-sectional view of the rear wheel assembly of the vehicle illustrated in FIG. 1;

FIG. 26(B) is a cross-sectional view of a rear wheel assembly according to yet a further alternative embodiment of the present invention;

FIG. 26(C) is a cross-sectional view of a rear wheel assembly according to yet a further alternative embodiment of the present invention;

FIG. 27 is a perspective view of a frame assembly according to yet another embodiment of the present invention, as viewed from the rear left side;

FIG. 28 is a perspective view thereof, as viewed from the forward left side;

FIG. 29 is a partial left side view thereof; and

FIG. 30 is a partial top view thereof.

### DETAILED DESCRIPTION OF PREFERRED EMBODIMENTS OF THE INVENTION

Before delving into the specific details of the present invention, it should be noted that the conventions “left,” “right,” “front,” “rear,” “up,” and “down” are defined according to the normal, forward travel direction of the vehicle being discussed. As a result, the “left” side of a vehicle corresponds to the left side of a rider seated in a forward-facing position on the vehicle.

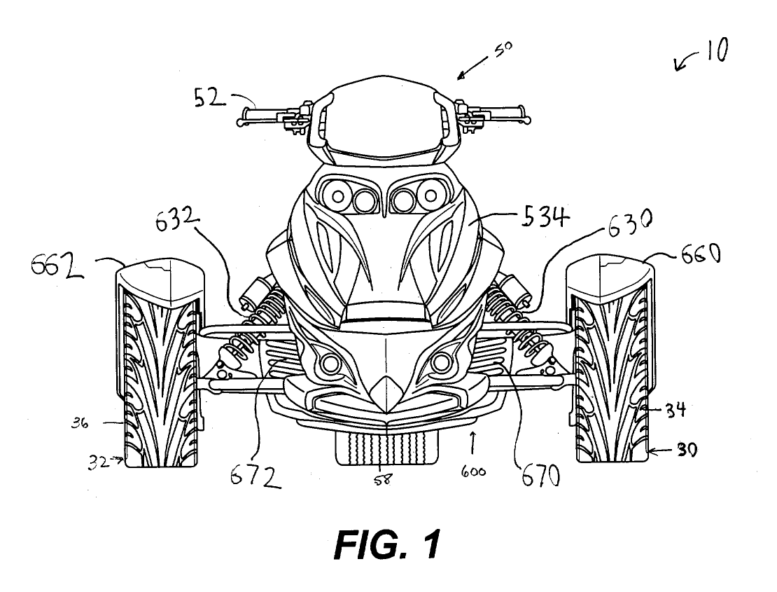

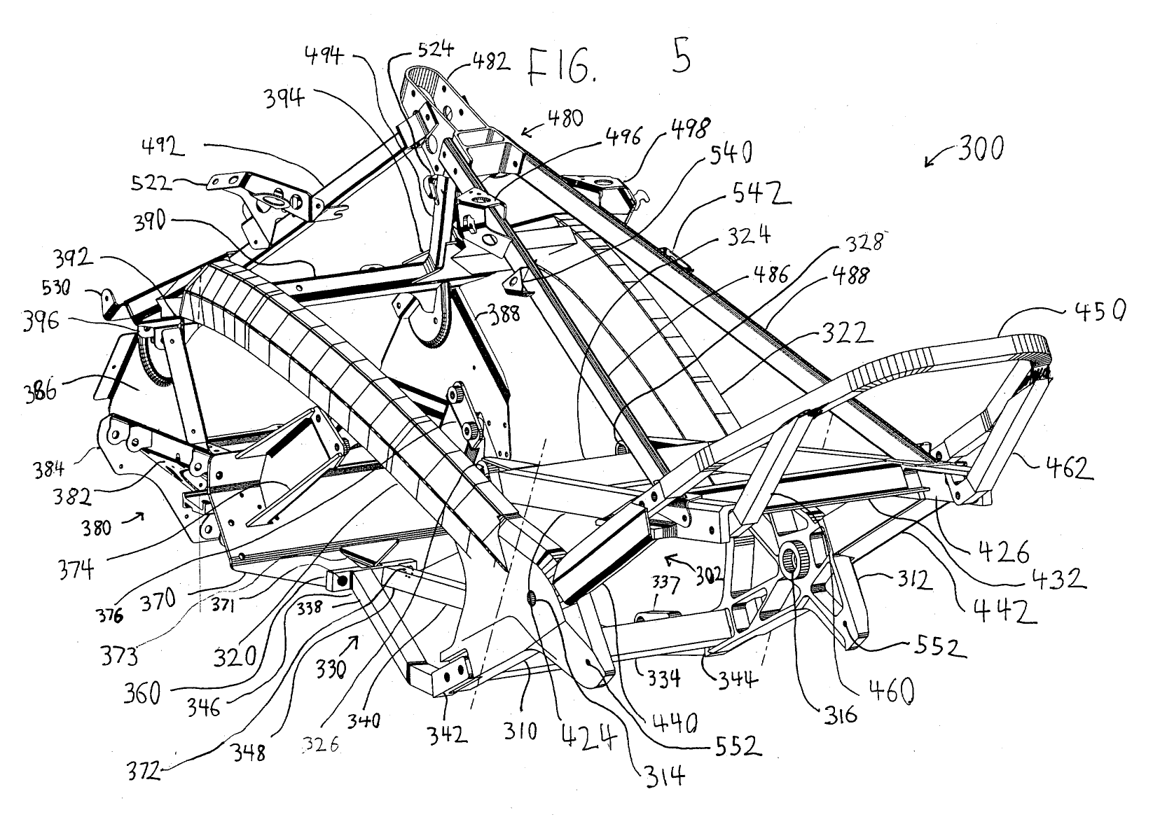

FIGS. 1-3 illustrate a three-wheel vehicle 10 according to the present invention. Left and right laterally spaced front wheels 30, 32 with left and right tires 34, 36 are supported by a front suspension system 600 (see FIG. 11). The front suspension system 600 is supported by a frame assembly 300 (see FIG. 5).

As illustrated in FIGS. 1, 2, 10, and 15, a steering assembly 50 is mounted to the frame assembly 300 and includes a handlebar 52 that is connected to a steering shaft 53 for common pivotal movement about a steering shaft axis. The handlebar 52 is designed to have approximately a 50 degree pivotal range (25 degrees to each side). The steering shaft 53 is operatively connected to the front wheels 30, 32 via a steering tie rod 55 to steer the vehicle 10.

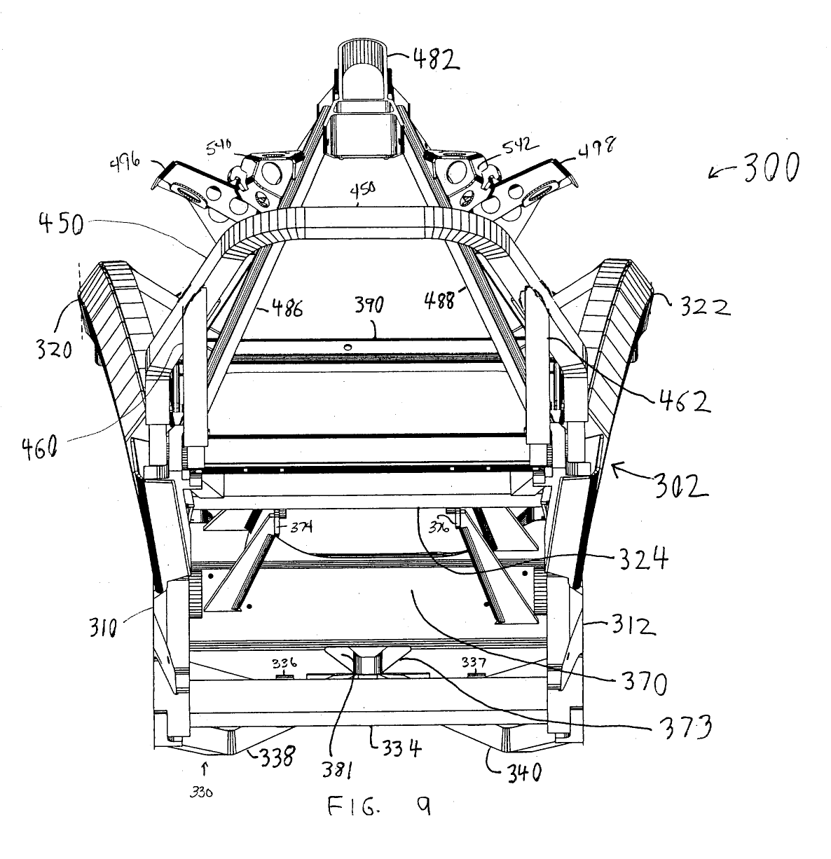

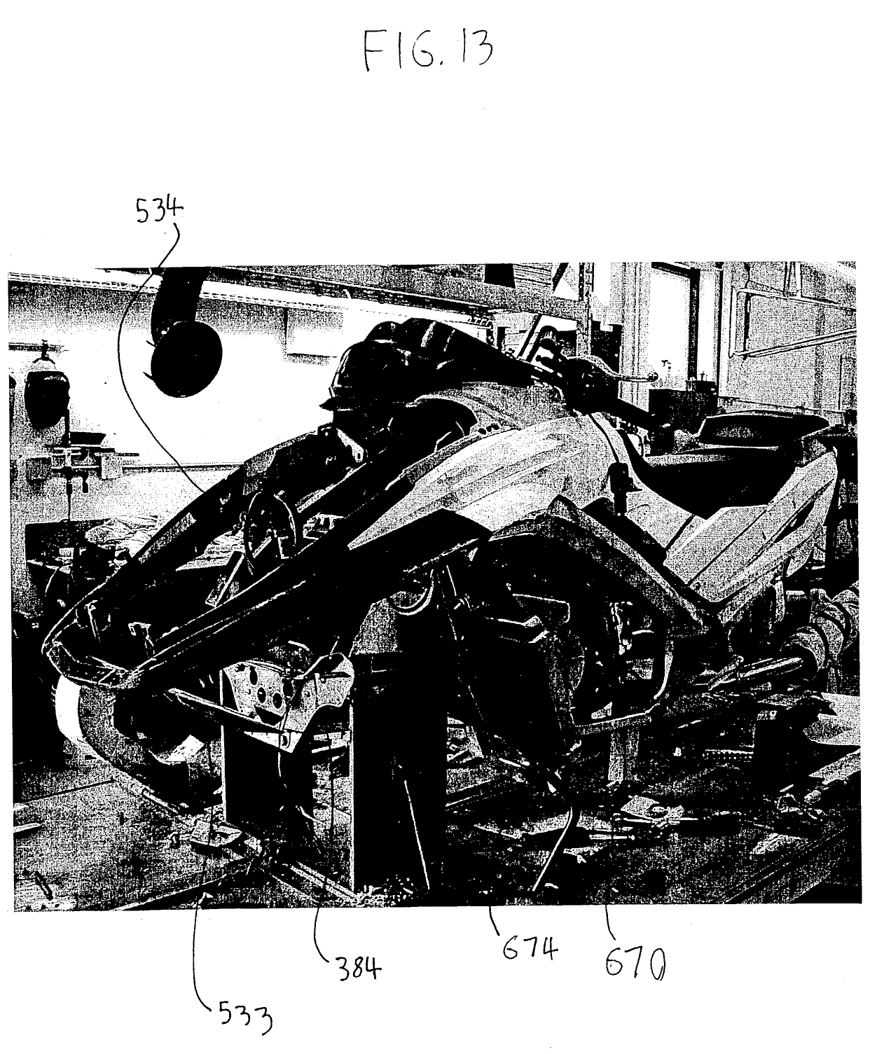

While not required of the present invention, the steering assembly 50 preferably includes a progressive steering system 51. As illustrated in FIG. 15, the progressive steering system 51 is preferably a mechanical system that includes a variable length moment arm. A swivel arm 51a is mounted to the steering shaft 53 for common rotation with the shaft 53 about a steering shaft axis. A radially-extending groove 51b is formed in the swivel arm 51a. A guide arm 51c is pivotally mounted (preferably with a bolt or screw) to a portion of the front suspension sub-frame 380 for pivotal movement relative to the front suspension sub-frame 380 about a guide arm axis. A ball-end 51d is mounted to the guide arm 51c. A ball bearing 51e fits onto the ball-end 51d and is positioned in the groove 51b so that it engages the inner surfaces of the groove 51b. Eye-ends 51f (only one is shown) connect to the ball-end 51d for relative pivotal movement to the ball-end 51d. Each eye end 51f connects to a tie rod 55 (see FIG. 10) of the steering assembly 50.

The progressive steering system 51 turns the wheels 30, 32 progressively more and more per degree of rotation of the handlebar 52 as the handlebar 52 is turned further away from a neutral position (aiming straight forward) to extreme left or right positions. As the handlebar 52 and the steering shaft 53 are turned farther away from their neutral position (shown in FIG. 15, the corresponding movement of the ball end 51d (and consequently the tie rods 55 and the wheels 30, 32) is amplified more and more by the guide arm 51c. This progressive steering system 51 along with other types of progressive steering systems that may alternatively be used with the steering assembly 50 are disclosed in U.S. Provisional Patent Application No. 60/358,396, titled “Progressive Steering System,” filed on Feb. 22, 2002, which is incorporated herein by reference.

The progressive steering system 51 enables the wheels 30, 32 to be turned to a greater extent (up to 45 degrees to each side) at the maximum angular displacement of the handlebar 52. This facilitates tight turning of the vehicle 10 despite the limited pivotal range of the handlebar 52. Conversely, the progressive steering system 51 also imparts greater turning torque to the wheels 30, 32 per degree of rotation of the handlebar 52 when the wheels are in their near-neutral position, as is most common during operation of the vehicle 10.

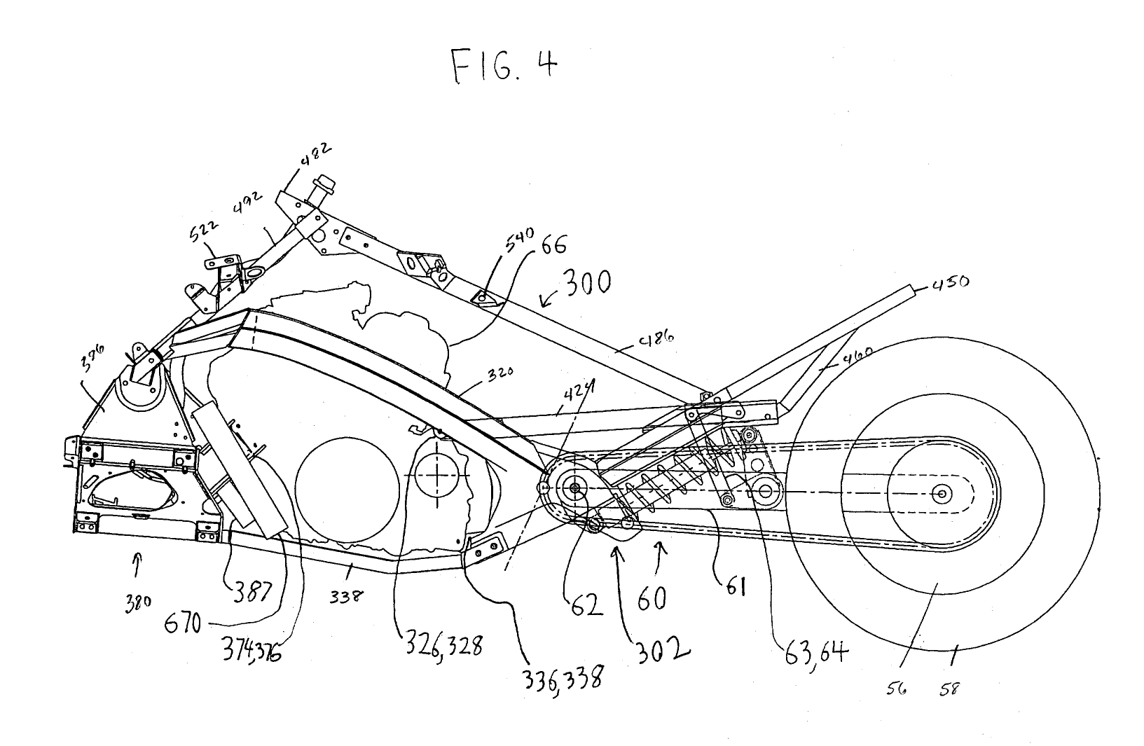

As illustrated in FIG. 4, a rear wheel 56 and tire 58 are supported by a rear suspension system 60. The rear suspension system 60 includes a swing arm 61 that is pivotally supported by the frame assembly 300 for movement relative to the frame assembly 300 about a laterally-extending swing arm axis 62. The rear suspension system further includes left and right rear suspension links 63, 64 that connect between the rear suspension system 60 and the frame assembly 300 to transfer the weight of a rider through the frame assembly 300 to the suspension system 60.

The wheels 30, 32, 56 are all preferably 15 inch wheels but may be any size. For example, one or more of the wheels 30, 32, 56 may be 13 inch wheels. The tires 34, 36, 58 are suitable for road use and may be automotive tires, for example.

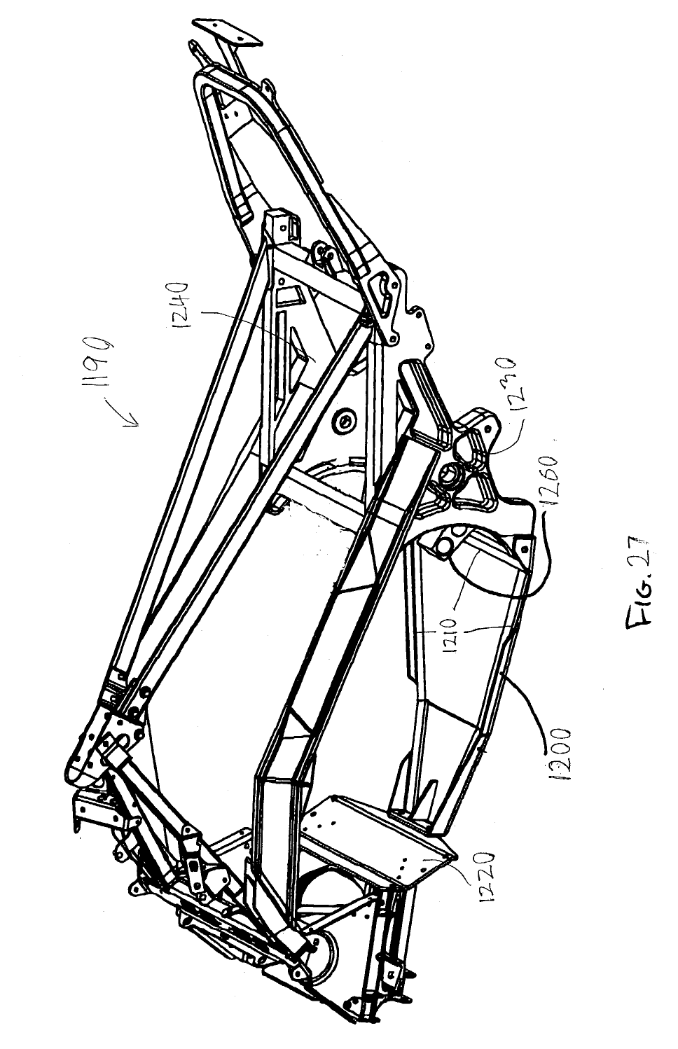

As illustrated in FIG. 26(A), a centerline 1000 of a patch (the footprint of a tire on the ground) of the tire 58 is located half way between the lateral sides of the tire 58.

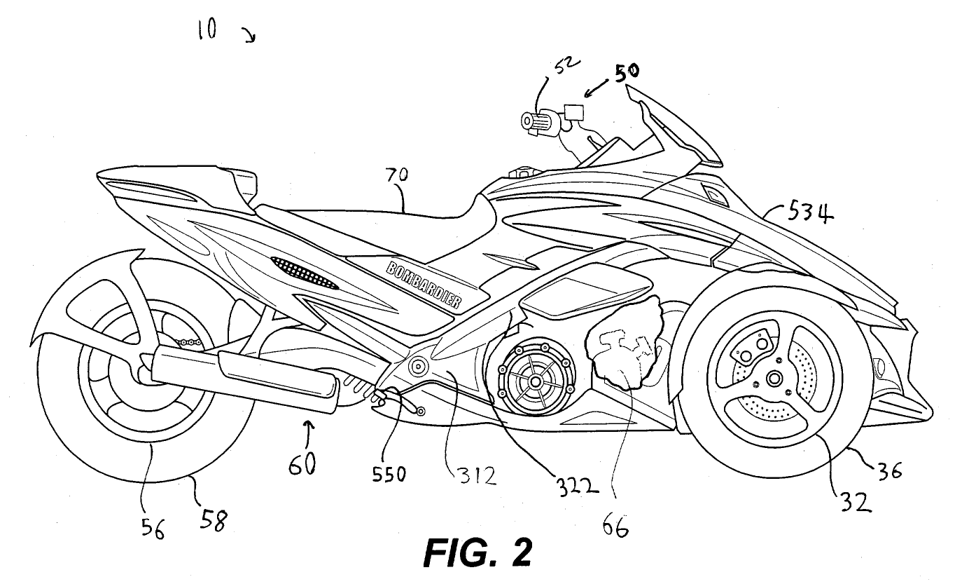

While the illustrated rear wheel 56 supports a single tire 58, vehicles according to the present invention may alternatively include more than one rear tire. For example, FIG. 26(B) illustrates a rear wheel assembly 1005 that may replace the rear wheel 56 and tire 58 illustrated in FIG. 2 without departing from the scope of the present invention. The rear wheel assembly 1005 includes a rear wheel 1010 with two rear tires 1020, 1030. The tires 1020, 1030 are supported by a rim 1015 of the wheel 1010 and are preferably laterally separated from each other. However, the rear tires 1020, 1030 may alternatively touch or connect to each other. Tire patch centerlines 1040, 1050 of the rear tires 1020, 1030, respectively, are separated from each other by a lateral distance that is preferably less than or equal to 460 mm.

FIG. 26(C) illustrates an additional alternative rear wheel assembly 1055, which may replace the rear wheel 56 and tire 58 illustrated in FIG. 2 without departing from the scope of the present invention. The rear wheel assembly 1055 includes a rear wheel 1060 and two rear tires 1070, 1080. In this embodiment, the rear wheel 1060 comprises two wheel subparts 1090, 1100 that are rigidly connected to each other via a central axle 1110. The wheel subparts 1090, 1100 define distinct rims 1095, 1105, respectively. The wheel subparts 1090, 1100 and axle 1110 may be integrally formed or may be mounted to each other after construction. The tires 1070, 1080 mount to the rims 1095, 1105, respectively, of the rear wheel 1060. Tire patch centerlines 1120, 1130 of the rear tires 1070, 1080, respectively, are separated from each other by a lateral distance that is preferably less than or equal to 460 mm. While the illustrated rear wheel assemblies include either one or two rear tires, three or more rear tires may alternatively be mounted onto a rear wheel without departing from the scope of the present invention.

In the context of the present invention, a single rear wheel may support one or more distinct tires. As discussed above, the wheel may be built in one piece or be composed of many assembled parts. Regardless of how many parts the wheel includes or how many rear tires are used, the single rear wheel is designed such that the rear tires cannot rotate relative to each other about the wheel's axis.

An engine 66 is supported by the frame assembly 300 and is operatively connected to the rear wheel 56 to power the vehicle 10. The engine 66 could alternatively be connected to the front wheels 30, 32 so that the vehicle 10 is a front-wheel drive vehicle. Alternatively, the engine 66 could be operatively connected to all three wheels 30, 32, 56 such that the vehicle would be all-wheel drive. The engine 66 is preferably a four stroke internal combustion engine, but may also be a two stroke engine. Because of the rigidity and improved structural strength of the frame assembly 300, which will be described below, the engine 66 can generate an output power of 80-135 horsepower or more. A 1000 cc v-type internal combustion engine manufactured by ROTAX® of Austria is preferred.

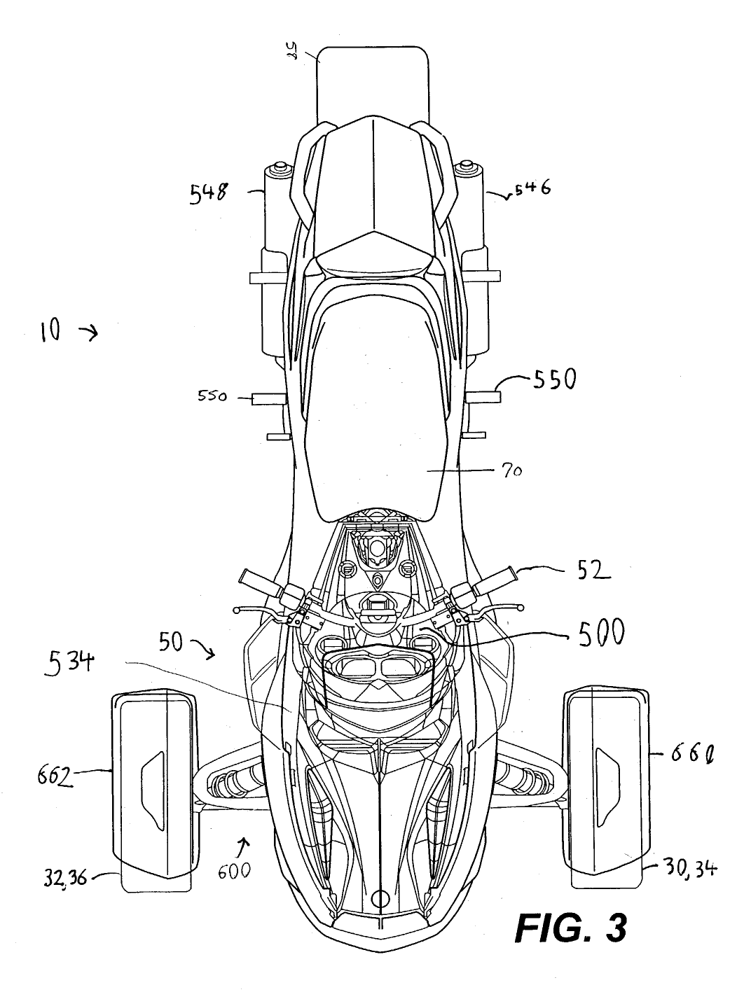

As shown in FIGS. 2 and 3, a cushioned rider seat 70 is mounted to the frame assembly 300 between the forward wheels 30, 32 and the rear wheel 56. The seat 70 illustrated is preferably designed to accommodate a single rider, in particular, the operator. However, as would be appreciated by those skilled in the art, it is possible to configure the seat 70 (and, accordingly, the vehicle 10) to accommodate two or more persons. The present invention is intended to encompass a three-wheeled vehicle of the type shown and described, regardless of the number of riders it is designed to accommodate.

As shown in FIG. 5, the frame assembly 300 of the vehicle 10 includes a rear suspension sub-frame 302 that includes left and right laterally-spaced rear suspension plates 310, 312. The rear suspension plates 310, 312 generally form vertically and longitudinally extending reinforced plates. The plates 310, 312 are preferably made of a strong, light material such as cast aluminum. Left and right laterally extending swing arm pivot bores 314, 316 are centrally disposed through each rear suspension plate 310, 312 to accommodate pivotal mounting of the rear suspension swing arm 61 thereon.

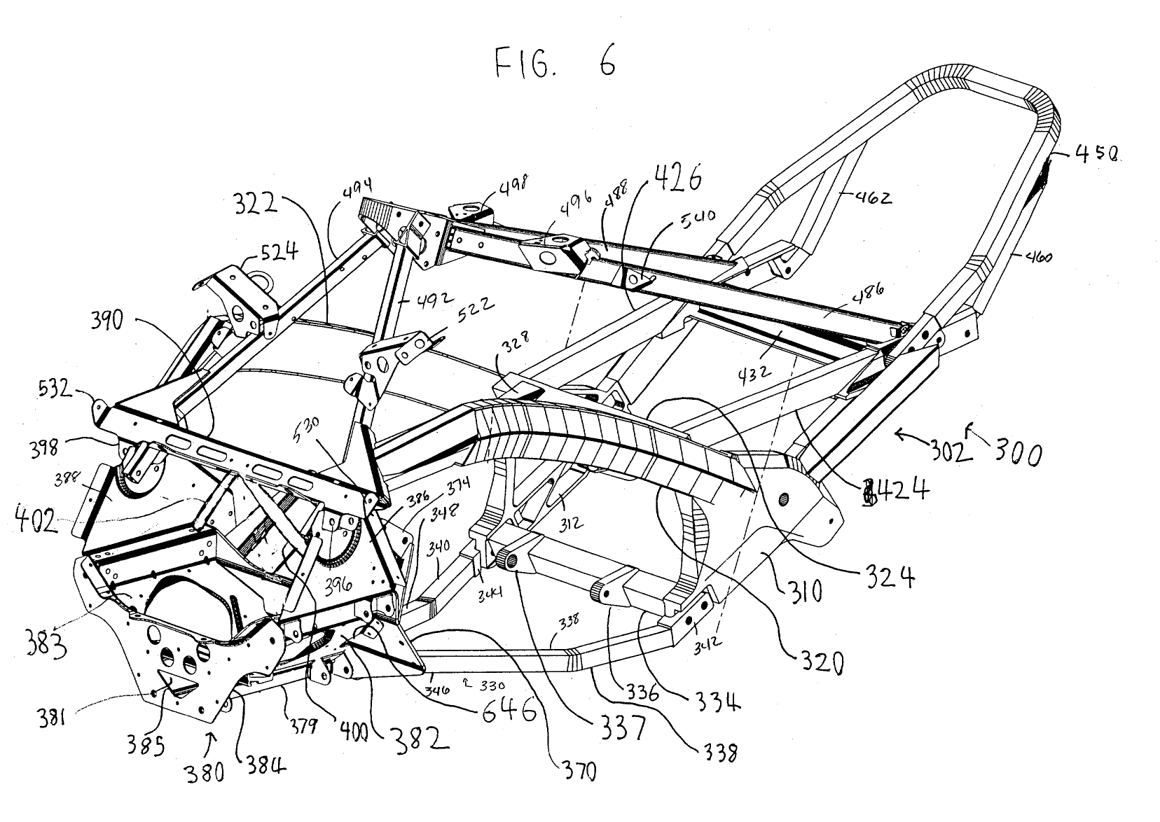

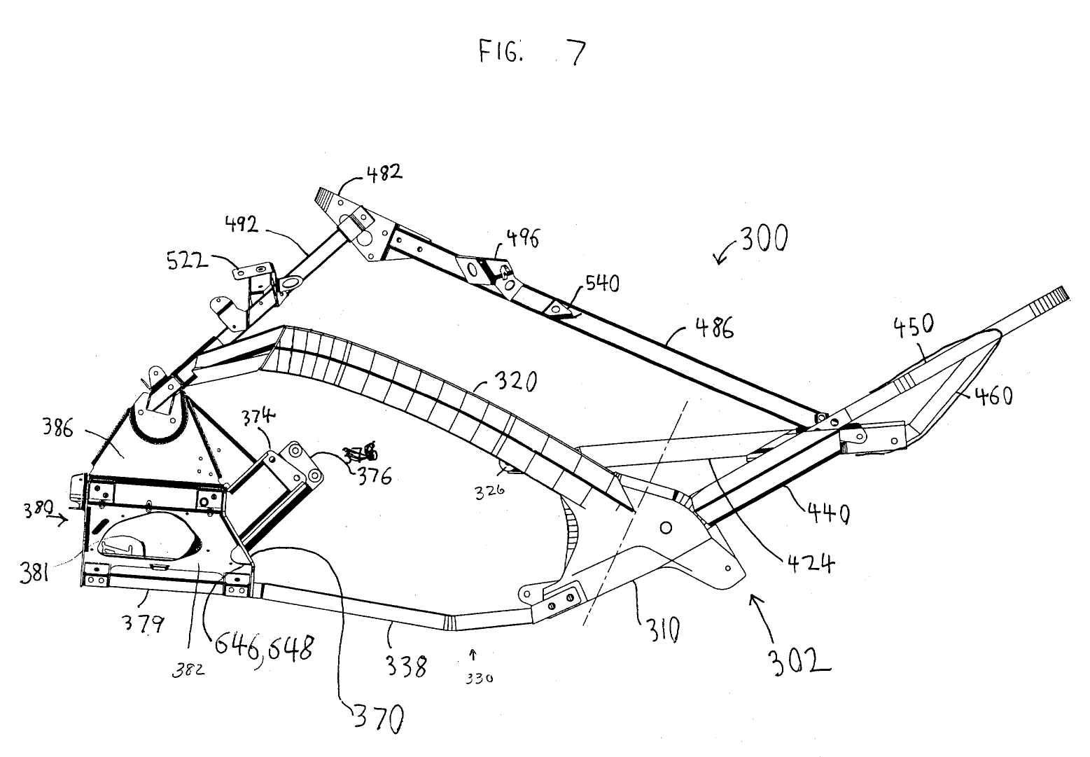

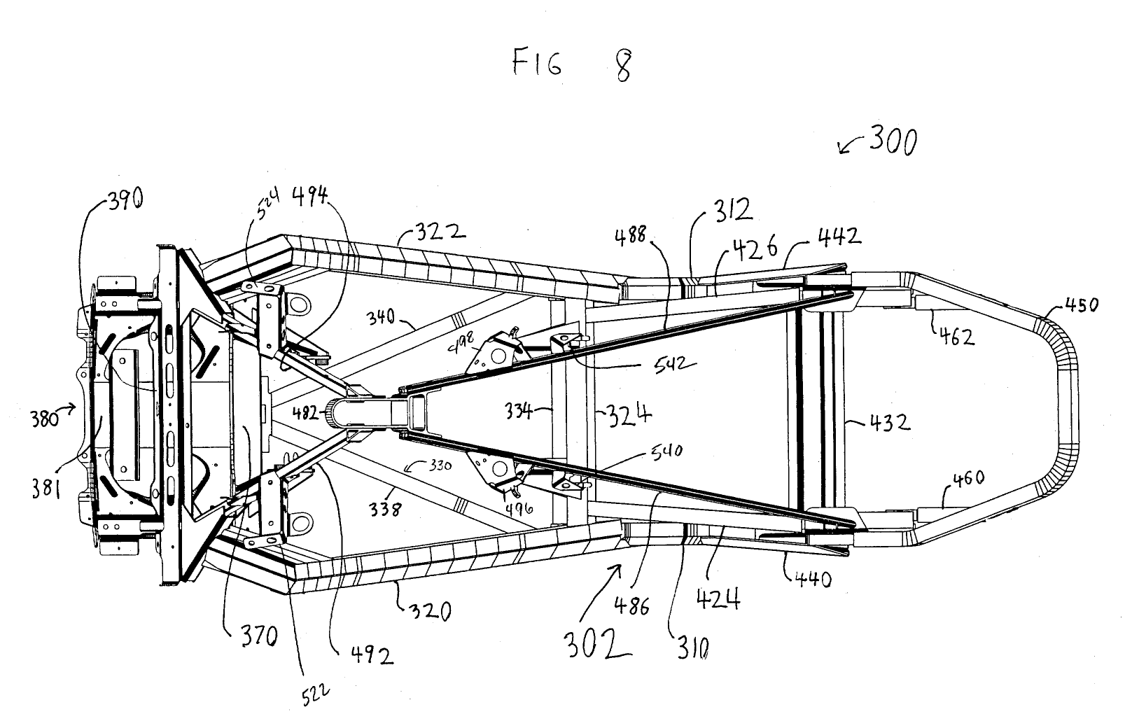

Laterally-spaced left and right upper spars (or main legs) 320, 322 extend upwardly and forwardly from upper forward portions of the left and right rear suspension plates 310, 312, respectively. The upper spars 320, 322 are formed as tubular members that provide lateral strength. The upper spars 320, 322 are welded to or otherwise integrally formed with the rear suspension plates 310, 312. As illustrated in FIG. 7, the upper spars 320, 322 arc slightly downwardly as they progress forwardly. As illustrated in FIGS. 8 and 9, the upper spars 320, 322 angle laterally outwardly as they progress forwardly from the plates 310, 312 and then angle laterally inwardly as they approach the forward ends of the upper spars 320, 322. As illustrated in FIG. 2, the outer side of the right upper spar 322 is visible from the side of the vehicle 10. The same is also true for the left upper spar 320.

As indicated above, the upper spars 320, 322 preferably are formed as tubular members. The term “tubular” is intended to encompass any construction where one or more of the frame elements are formed as hollow elements. In particular, a hollow element is defined as one that provides torsional rigidity to a frame (among other benefits and advantages) either alone or when combined with other frame elements. While the appellation “tubular frame” is used herein, the term “tubular” is meant to encompass more than what those of ordinary skill in the art would consider to be tubular. FIGS. 19-23 and the discussion that follows provide an explanation of the breadth of the term “tubular” as used herein.

FIG. 19 illustrates a first embodiment of the upper spars 320, 322 contemplated to fall within the scope of the present invention. In this embodiment, the tubular member 800 comprises a concave portion 802 and a flat portion 804. Preferably, both the concave portion 802 and the flat portion 804 are made from aluminum or a metal where aluminum is at least a component (e.g., a composite material). Of course, as would be appreciated by those skilled in the art, any other suitable material may be substituted therefor, such as steel, magnesium or an alloy containing magnesium, titanium or an alloy containing titanium, a composite material, a ceramic, or a composite including carbon fibers. This list of materials is not meant to be exhaustive. To the contrary, the scope of the present invention is intended to encompass a wide variety of materials that may be used to manufacture the upper spars 320, 322 or any other portion of the frame assembly 300. Moreover, it is contemplated that the individual components of the frame assembly 300 each may be made of different materials without deviating from the scope of the present invention.

Before continuing with the discussion of other tubular frames, it is noted that the concave portion 802 may be manufactured according to any of a variety of techniques. For example, the concave portion may be cast, forged, stamped, or extruded. The same is true for any other element of the frame assembly 300. The exact manufacturing technique is not critical to the practice of the present invention, as would be appreciated by those skilled in the art.

Returning to FIG. 19, the concave portion 802 and the flat portion 804 are connected to one another at connection portion 806. Connection portion 806 may be welds that run the entire length from one end of the upper spar 320, 322 to the other. Alternatively, connection portion 806 may be one spot weld of several along the length of the upper spar 320, 322. In yet another alternative, the concave portion 802 may be connected to the flat portion 804 via a suitable adhesive at the connection portion 806. The exact means by which the concave portion 802 is connected to the flat portion 804 is not critical to the practice of the present invention.

In addition, while FIG. 19 illustrates the connection of two portions 802, 804 together, the present invention is meant to encompass frame elements 800 that comprise any number of elements greater than or equal to one.

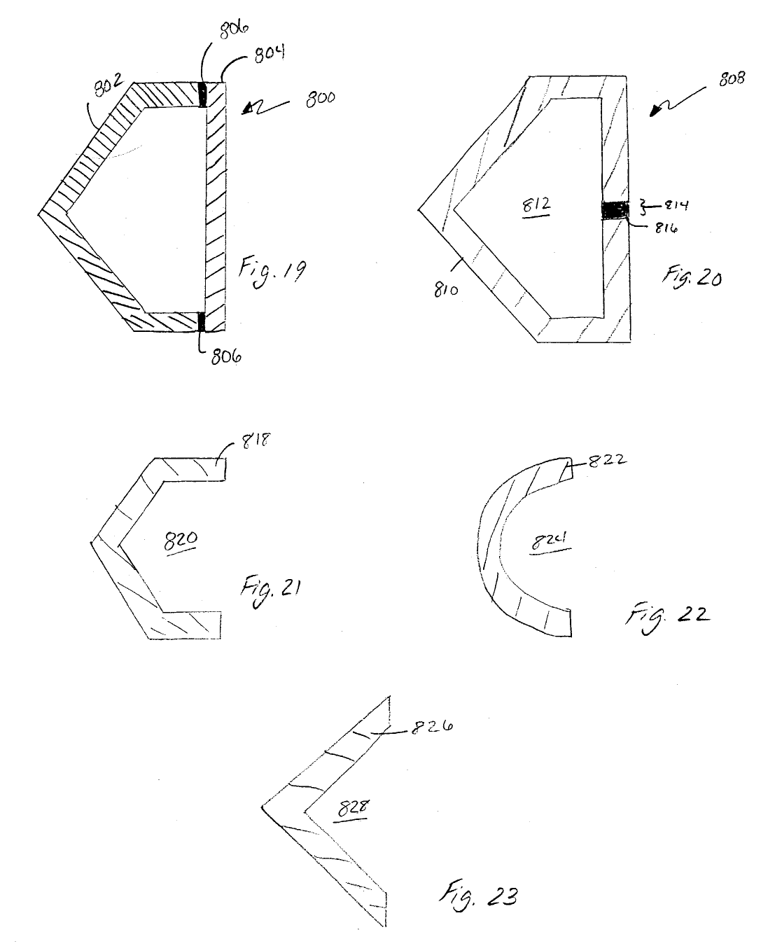

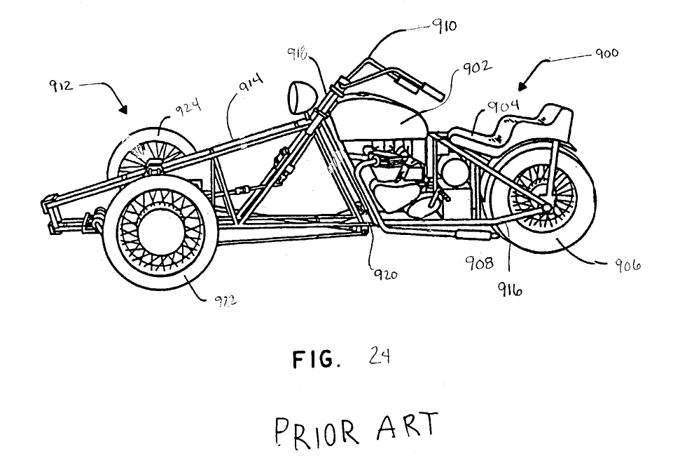

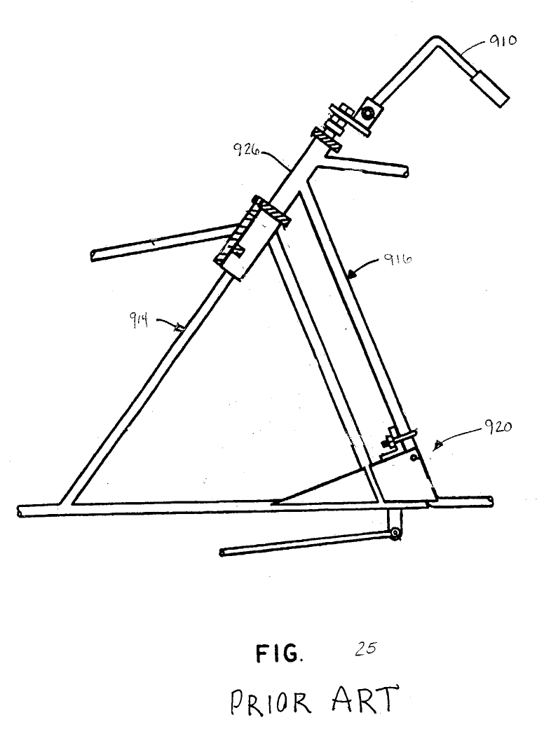

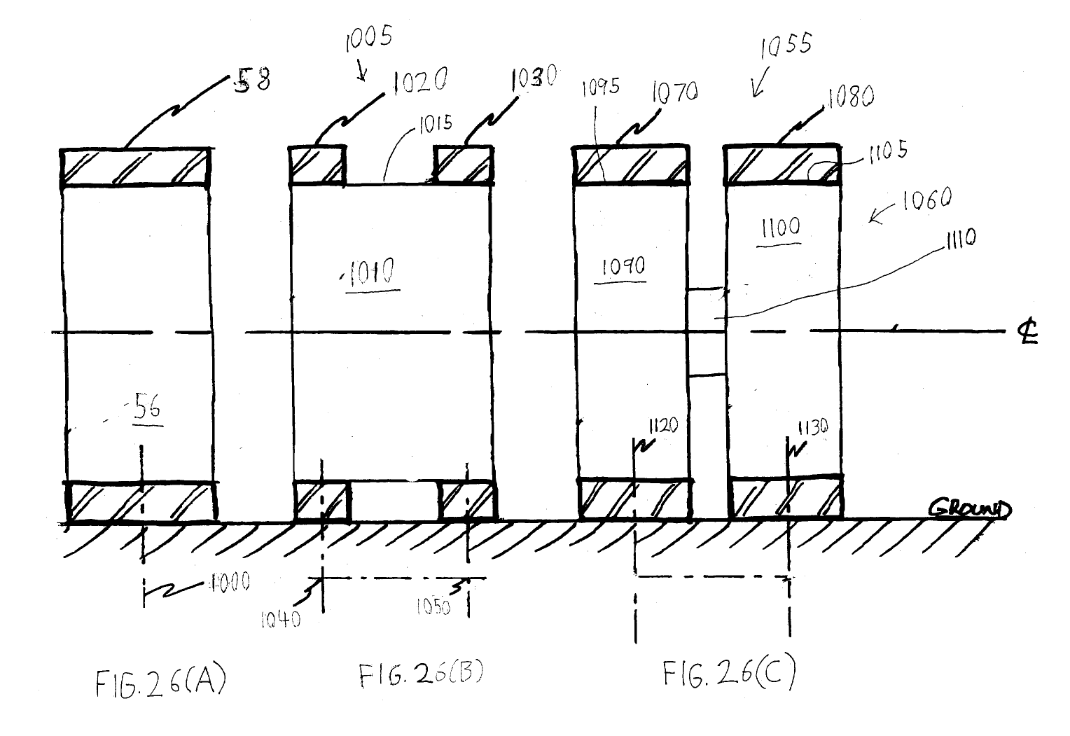

FIG. 20 illustrates the cross-section of a tubular member 808. In this embodiment, the tubular member 808 includes a roughly C-shaped body portion 810 defining a hollow channel 812 therein. In this example, which is well-suited for extrusion, the gap 814 is closed by a connection portion 816 formed by continuous welding or by spot welding, for example. Other connecting portions 816, such as adhesives, may also be used as would be appreciated by those skilled in the art.

FIG. 21 illustrates a cross-section of a third embodiment of a tubular member 818. Here, the tubular member defines a cavity 820 that is not bounded on all sides, as in the previous two embodiments. It is believed that the tubular member 818 will provide sufficient structural strength and rigidity as the previous example. However, this particular embodiment offers the advantage of decreased weight as compared to the previous examples.

FIG. 22 illustrates a fourth embodiment of a tubular member 822 constructed in accordance with the teachings of the present invention. In this embodiment, the tubular member 822 forms a cavity 824 that is not bounded. This embodiment, therefore, is similar to the embodiment illustrated in FIG. 21. This embodiment differs from that embodiment in that it presents a curved cross-section, rather than an angular one, as in the embodiment illustrated in FIG. 21. While a generally semi-circular cross-section is illustrated for this embodiment, it is contemplated that the tubular member 822 could present a semi-ovoid cross-section. In addition, the tubular member 822 could present a non-symmetric cross-section, which is also true for all of the embodiments described and to the larger variety of embodiments contemplated to fall within the scope of the present invention.

FIG. 23 illustrates a cross-section for a tubular member 826 that is also contemplated to fall within the scope of the present invention. Here, the tubular member 826 has a V-shaped cross-section defining a cavity 828. It is contemplated that this embodiment presents the smallest cross-sectional aspect for any of the tubular members that make up the frame assembly 300.

Returning to FIG. 8, a tubular rear upper engine support cross brace 324 extends laterally between rearward portions of the left and right upper spars 320, 322. The cross brace 324 is preferably welded to the left and right upper spars 320, 322, but may alternatively be bolted, riveted, or otherwise rigidly fastened to the upper spars 320, 322. The rear upper engine support cross brace 324 could alternatively be connected directly to upper forward portions of the left and right rear suspension plates 310, 312. As shown in FIGS. 6 and 7, laterally spaced left and right upper rear engine anchors 326, 328 are welded to and extend forwardly from the rear upper engine support cross brace 324.

As illustrated in FIG. 6, an engine cradle assembly 330 extends forwardly from the lower front ends of the rear suspension plates 310, 312. The engine cradle assembly 330 includes a rear lower engine support cross brace 334 that extends laterally between the lower front ends of the left and right rear suspension plates 310, 312. The cross brace 334 is formed as a tubular member for strength and rigidity and is preferably welded to the rear suspension plates 310, 312. As would be appreciated by those skilled in the art, the cross-brace 334 may be affixed to the rear suspension plates 310, 312 via any other suitable fasteners or elements. Laterally spaced left and right lower rear engine anchors 336, 337 extend forwardly from the engine support cross brace 334 and include engine mounting holes. The lower rear engine anchors 336, 337 are preferably welded to the engine support cross brace 334. In the illustrated embodiment, the engine 66 mounts directly to the lower rear engine anchors 336, 337. However, the engine 66 may alternatively indirectly mount to the lower rear engine anchors 336, 337 via an intermediate connector such as an engine mounting plate (not shown). Moreover, the lower rear engine anchors 336, 337 may be used to operatively support drive train components other than or in addition to the engine 66. For example, a continuously variable transmission that is operatively connected to the engine 66 may be mounted to the lower rear engine anchors 336, 337.

The engine cradle assembly 330 also includes tubular left and right lower spars 338, 340 having rearward portions 342, 344 that are bolted to the lower forward ends of the left and right rear suspension plates 310, 312, respectively. The lower spars 338, 340 extend forwardly and laterally-inwardly from their respective rearward portions to their forward portions 346, 348.

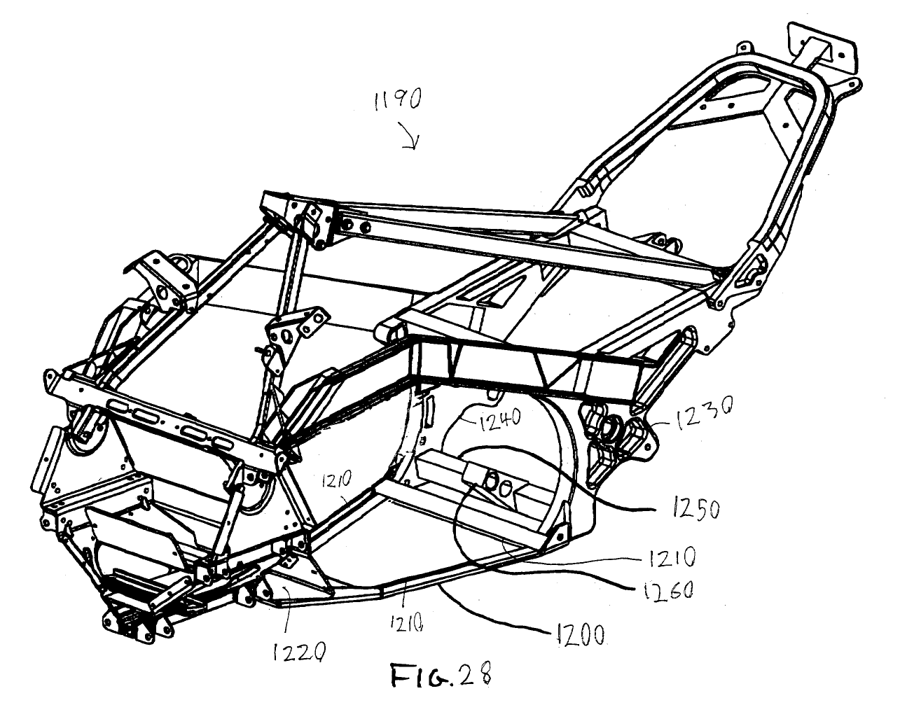

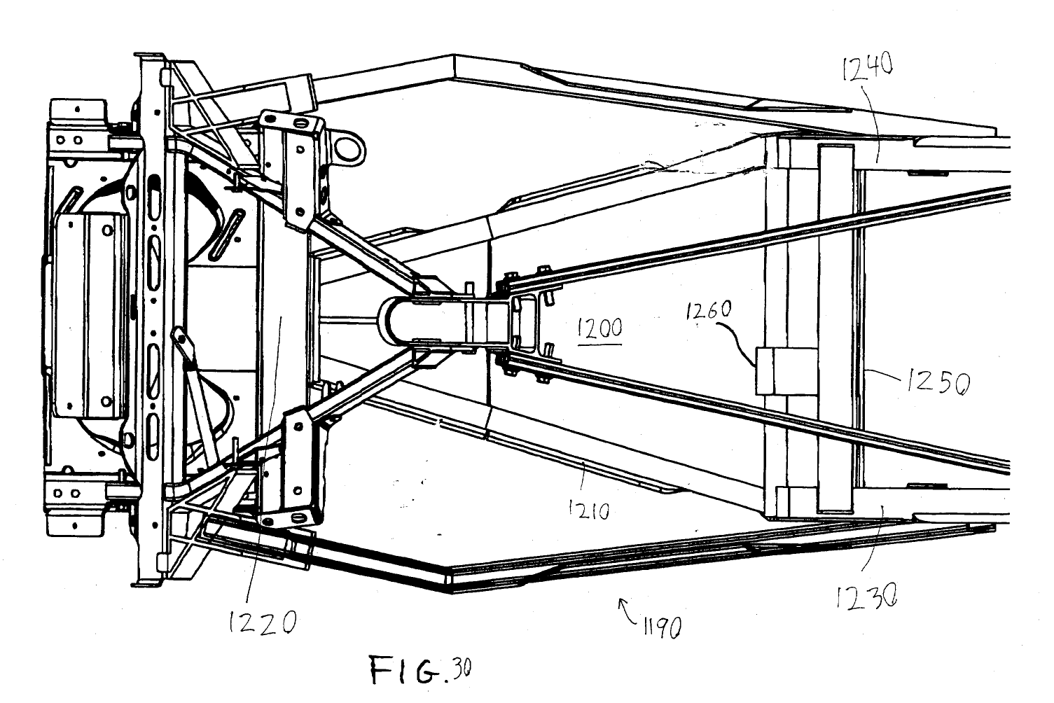

As illustrated in FIG. 5, a laterally extending lower spar bracket 360 is connected to the forward portions 346, 348 of the lower spars 338, 340. The lower spar bracket 360 is preferably welded to the forward portions 346, 348 of the lower spars 338, 340. Alternatively, the lower spars 338, 340 and the lower spar bracket 360 may be integrally formed (such as by aluminum casting or sheet metal stamping) into a wishbone-shaped composite lower spar (see, for example, the bottom plate 1200 illustrated in FIGS. 27-30).

The left and right lower spars 338, 340 and the engine support cross brace 334 generally form a triangle when viewed from above. Because the cross brace 334 and lower spars 338, 340 are formed of tubular members, the engine cradle assembly 330 forms a strong and rigid sub-frame assembly.

As illustrated in FIG. 5, the engine cradle assembly 330 further includes a forward engine cradle plate 370 that is bolted to a forward portion of the lower spar bracket 360 with left and right bolts 371, 372. The plate 370 generally extends vertically and laterally. Left and right forward engine anchors 374, 376 extend rearwardly and upwardly from the plate 370 and include engine mounting holes. The engine anchors 374, 376 are preferably bolted to the engine cradle plate 370, but may also be welded, riveted, or otherwise rigidly fastened to the engine cradle plate 370. Because the engine cradle plate 370 serves numerous structural functions in the frame assembly 300, it preferably comprises a thick aluminum plate that is preferably about 0.25 in. (10 mm) thick. Several small bends along lateral fold lines further improve the rigidity of the plate 370. As shown in FIG. 9 and explained in greater detail below, the engine cradle plate 370 includes a generally triangular or trapezoidal aperture 373, which forms at least one air inlet to the engine 66.

Because the rearward portions 342, 344 of the lower spars 338, 340 are bolted to the rear suspension plates 310, 312 and the lower spar bracket 360 is bolted to the engine cradle plate 370, the lower spars 338, 342 and lower spar bracket 360 may be detached from the frame assembly 300 as a unit in order to provide access to the engine 66 without having to disassemble the frame assembly 300 components. While not shown, a bottom plate (see, for example, FIGS. 27-29) may extend between and mount to (via welds, bolts, integral formation, etc.) the lower spars 338, 340 to strengthen the lower spars 338, 340 and protect the underside of the engine 66

As shown in FIGS. 6 and 7, a front suspension sub-frame 380 is connected (preferably with bolts) to a forward end of the engine cradle plate 370. The front suspension sub-frame 380 includes a longitudinally extending tubular beam 381. The beam 381 is an extruded hollow member having a generally trapezoidal or triangular cross section with the long parallel edge of the trapezoid on top (see FIGS. 9 and 10). A generally V-shaped plate 379 includes left and right outwardly extending side panels 382, 383 that extend upwardly, outwardly, and longitudinally from a generally flat longitudinally-oriented vertex. The V-shaped plate 379 forms a “V” when viewed from the front. The tubular beam 381 is connected (preferably via welding) to the inside of the vertex of the V-shaped plate 379 to form a V-shaped assembly. The outwardly extending side panels 382, 383 include large central apertures through which the tie rods 55 of the steering assembly 50 extend. The rear edge of the V-shaped assembly is connected (preferably with rivets, welds, or bolts) to the engine cradle plate 370, whose lateral bends follow the rear edge of the V-shape assembly (see FIG. 7).

While the illustrated V-shaped assembly is a composite structure that includes the beam 381 and V-shaped plate 379, the V-shaped assembly could also be constructed from a single sheet of material in which a tubular or semi-tubular beam is formed by bending the sheet at a vertex of a V-shape to form the structure corresponding to the beam 381. Alternatively, separate side plates corresponding to the side panels 382, 383 could be welded to the side of a beam like the beam 381 to form the V-shaped assembly.

Continuing with reference to FIGS. 4, 6 and 7, the sub-frame 380 further includes a vertically and laterally extending forward plate 384 that is connected (preferably with welds, rivets, or bolts) to the front end of the V-shaped assembly. The forward plate 384 includes a generally triangular or trapezoidal aperture 385 that opens into the hollow inside of the tubular beam 381. The rear end of the hollow beam 381 is aligned with the triangular or trapezoidal aperture 373 in the engine cradle plate 370. Consequently, air can flow into the aperture 385 in the forward plate, through the hollow beam 381, out of the aperture 373 in the engine cradle plate 370, into the engine 66 compartment (i.e., the opening formed within the engine cradle assembly 330) and around an oil cooler 387 of the engine 66 to cool the engine oil. The air may also be directed to the intake of the engine 66.

Together, the variously oriented plates/panels 370, 382, 383, 384 and the tubular beam 381 provide a strong, rigid sub-frame 380 onto which the front suspension 600 is mounted.

Left and right vertically and longitudinally extending side panels 386, 388 extend upwardly from the left and right outwardly extending panels 382, 383, respectively, of the V-shaped assembly. Each side panel 386, 388 forms a triangle having a flat lower side attached to the flat upper edge of the corresponding outwardly extending side panel 382, 383 of the V-shaped assembly. Each vertically extending side panel 386, 388 may be welded to its corresponding outwardly extending side panel 382, 383. Alternatively, each vertically extending side panel 386, 388 may be integrally formed with its corresponding outwardly extending side panel 382, 383, a bend in the sheet material of the V-shaped plate 379 defining the attachment edge between adjoining panels 382, 386 and 383, 388.

Referring to FIGS. 5 and 6, a laterally-extending front cross brace 390 connects between upper ends of the side panels 386, 388 (i.e., at the upper vertices of the triangles formed by the side panels 386, 388) of the front suspension sub-frame 380 at left and right connection points 392, 394. Forward ends of the left and right upper spars 320, 322 likewise connect to the front cross brace 390 at the left and right connection points 392, 394, respectively. The front cross brace 390 extends laterally outwardly beyond the connection points 392, 394 on its left and right sides to provide left and right front suspension/shock absorber anchors 396, 398. The front cross brace 390 preferably bolts (or otherwise removably fastens) to the front suspension sub-frame 380 and the upper spars 320, 322.

As illustrated in FIG. 6, left and right diagonal front suspension braces 400, 402 connect between lower rearward edges of the left and right side panels 386, 388, respectively, and a middle portion of the front cross brace 390 such that the diagonal braces 400, 402 combine to form an upside-down V-shape. Consequently, as viewed from the front, a triangle is formed between the cross brace 390, the left brace 400, and the left side panel 386. A similar triangle is formed between the cross brace 390, the right diagonal brace 402, and the right side panel 388. A further triangle is generally formed between the upper part of the forward engine cradle plate 370 and the two diagonal braces 400, 402. The multiple triangles add additional structural rigidity to the frame assembly 300. The diagonal braces 400, 402 could also be positioned in a variety of different ways. For example, instead of forming an upside down V, the braces 400, 402 could form an X-shape, each brace 400, 402 extending from a lower edge of one side panel 386, 388 to an upper edge of the opposite side panel 386, 388.

The front cross brace 390 is subjected to tension and compression when the front shock absorbers 630, 632 compress and expand. The front cross brace is also subjected to bending forces at its middle portion where it is connected to the diagonal braces 400, 402. The cross brace 390 must therefore be extremely strong and rigid. To provide sufficient strength and rigidity, the illustrated cross brace 390 is a folded elongated piece of sheet metal that has a generally U-shaped cross-section along its longitudinal axis (i.e., along the lateral direction of the vehicle 10). However, the cross brace 390 could also be an extrusion. Oblong holes are cut out of the cross brace 390 to lighten it.

As shown in FIGS. 6-8, the rear suspension sub-frame 302 further includes left and right tank support members 424, 426. The tank support members 424, 426 include forward portions that are connected to the upper rear engine support cross brace 324 laterally outwardly from where the upper rear engine anchors 326, 328 are connected to the cross brace 324 and laterally inwardly from where the cross brace 324 is connected to the upper spars 320, 322. As illustrated in FIG. 8, the tank support members 424, 426 include rearward portions that are generally parallel and extend in the longitudinal direction of the vehicle 10. Forward portions of the tank support members 424, 426 angle slightly laterally inwardly as the progress longitudinally/forwardly toward the rear upper engine support cross brace 324. The forward and rearward portions of each tank support member 424, 426 may be integrally formed or may be separately connected pieces.

Referring to FIG. 8, the rear suspension sub-frame 302 further includes a rearward laterally-extending rear suspension cross brace 432 that connects between rearward portions of the tank support members 424, 426.

Referring to FIG. 7, the rear suspension sub-frame 302 further includes left and right rear suspension braces 440, 442 that extend upwardly and rearwardly from the upper rearward portions of the rear suspension plates 310, 312 to the rearward portions of the tank support members 424, 426. Consequently, the rear suspension plates 310, 312, the rear suspension braces 440, 442, and the tank support members 424, 426 generally form triangles when viewed from the side.

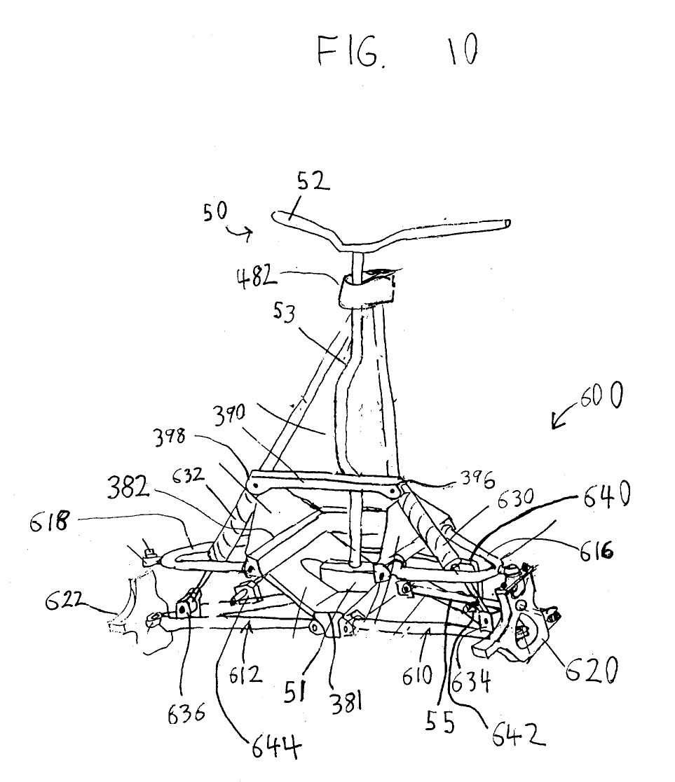

As illustrated in FIG. 12, the rear suspension cross brace 432 comprises a folded sheet metal piece having a generally upside down U-shaped cross section. Left and right rear suspension link anchors 434, 436 are welded to the inside of the upside down U shape. Eye-ends 438 are pivotally connected to the rear suspension link anchors 434, 436 and rigidly connected to the rear suspension links 63, 64 (see FIG. 4) of the rear suspension system 60.

Referring to FIGS. 7 and 9, the frame assembly 300 further includes a U-shaped rear sub-frame (or passenger support sub-frame) 450. The rear sub-frame 450 has ends that connect to the left and right rear suspension braces 440, 442, respectively, such that the rear sub-frame 450 extends upwardly and rearwardly from the rear suspension braces 440, 442 and the rearward portions of the tank support members 424, 426. Left and right rear sub-frame braces 460, 462 connect between rear ends of the rearward portions of the tank support members 424, 426 and intermediate portions of the rear sub-frame 450 such that the tank support members 424, 426, rear sub-frame 450, and rear sub-frame braces 460, 462 generally form a triangle when viewed from the side of the assembly 300. By this, downward forces on the rear sub-frame 450 are transferred to the frame assembly 300.

As shown in FIGS. 5-9, the frame assembly 300 also includes a pyramid-shaped upper support assembly (or upper column assembly) 480 that extends upwardly from the tank support members 424, 426 and front cross brace 390 at the connection points 392, 394. The apex is a steering column bracket (or upper holder) 482. As illustrated in FIG. 10, the steering shaft 53 is pivotally mounted to and extends through the steering column bracket 482.

The steering column bracket 482 may alternatively be mounted to any other convenient portion of the frame assembly 300. For example, if the upper support assembly 480 were eliminated, a steering column bracket could be supported by a cross brace that extends between the upper spars 320, 322. Alternatively, the steering column bracket could be supported by one or both of the upper spars 320, 322 directly. Generally, the steering shaft 53 may be pivotally connected to any two frame assembly 300 components (e.g., front suspension sub-frame 380, upper spar(s) 320, 322, upper support assembly 480, front cross brace 390, etc.). The steering shaft 53 may alternatively be pivotally connected to just one frame assembly 300 component.

Left and right upper column rear members 486, 488 connect between the rearward portions of the left and right longitudinal legs 424, 426, respectively, and the steering column bracket 482. Each upper column rear member 486, 488 extends upwardly, forwardly, and inwardly from the rearward portion of its respective longitudinal leg 424, 426 to the steering column bracket 482. Consequently, the left upper column rear member 486, right upper column rear member 488, and the rear suspension cross brace 432 generally form a triangle when viewed from the rear and/or top.

The upper support assembly 480 further comprises left and right upper column front members 492, 494 connected between the left and right connection points 392, 394, respectively, on the front cross brace 390 and the steering column bracket 482. Each upper column front member 492, 494 extends upwardly, rearwardly, and inwardly from its respective connection point 392, 394 on the front cross-brace 390 to the steering column bracket 482. Consequently, the upper column front members 492, 494 and front cross brace 390 generally form a triangle when viewed from the front and/or top.

While the pyramid-shaped upper support assembly 480 is not required for the structural strength and/or rigidity of the frame assembly 300, the upper support assembly 480 provides anchor points for a variety of vehicle 10 components. For example, the fuel tank 543 is supported by the upper support assembly 480.

The upper support assembly 480 need not be included in a frame assembly 300 according to the present invention. For example, if the upper support assembly 480 were eliminated, a steering bracket like the steering column bracket 482 could be mounted to any other suitable component of the frame assembly 300. Similarly, other components that are illustrated as being mounted to the upper support assembly 480 could either be eliminated, moved, or mounted to other frame components without deviating from the scope of the present invention.

Console anchors 496, 498 are mounted to upper forward portions of the left and right upper column rear members 486, 488, respectively. A console 500 (see FIG. 3) with various display panels and gauges is mounted to the console anchors 496, 498.

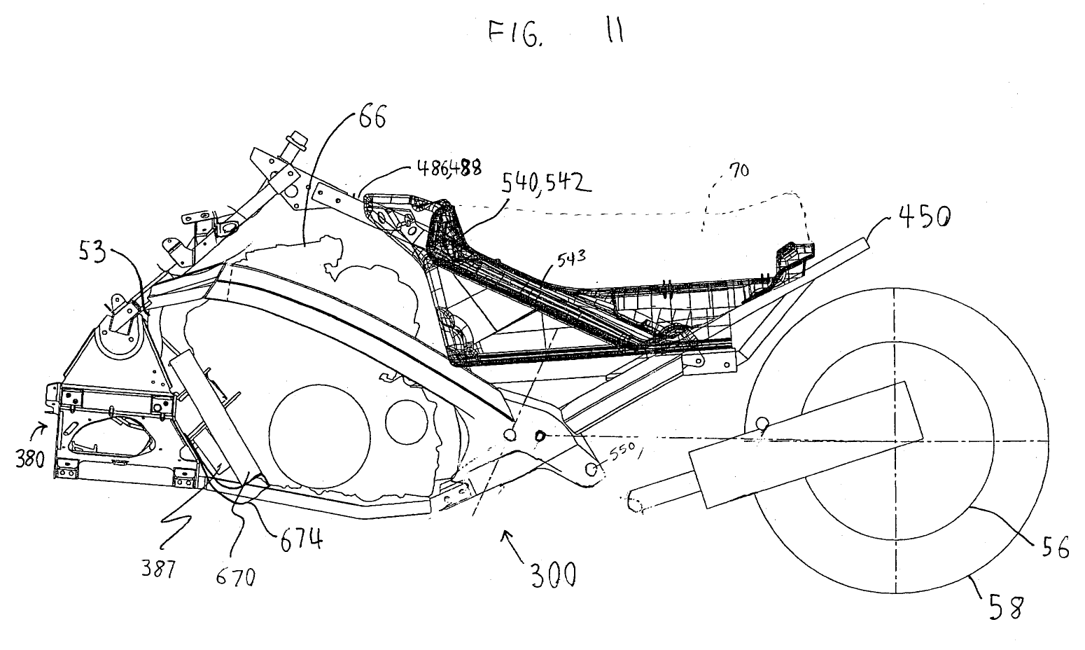

Left and right forward upper fairing anchors 522, 524 are mounted to intermediate portions of the left and right upper column front members 492, 494, respectively. Similarly, left and right forward lower fairing anchors 530, 532 are formed at the left and right ends of the front cross brace 390. Additional fairing anchors 533 extend forwardly from the forward plate 384 to support the far forward end of the forward fairing 534 (See FIG. 13). The forward fairing 534, which is preferably made fiberglass with a gelcoat, is attached to the body anchors 522, 524, 530, 532.

Left and right tank anchors 540, 542 are attached to intermediate portions of the left and right upper column rear members 486, 488, respectively. As illustrated in FIG. 11, the fuel tank 543 is mounted onto the seat anchors 540, 542, the upper column rear members 486, 488, the longitudinal legs 424, 426, and the U-shaped rear sub-frame 450. Because of the pyramid shape of the upper support assembly 480, the weight of the fuel tank that is exerted on the upper column rear members 486, 488 will be distributed over the front and back of the frame assembly 300.

As shown generally in FIG. 11, the seat 70 is positioned above the fuel tank 543 so that a weight of the rider thereon will be disposed generally above the rear suspension cross brace 432, which supports the rear suspension links 63, 64. Consequently, a majority of the weight of the rider will be transferred through the seat 70 and frame assembly 300 to the rear suspension cross brace 432, and from the rear suspension cross brace 432 to the rear suspension system 60.

As illustrated in FIG. 4, the engine 66 is mounted to the forward engine anchors 374, 376, the upper rear engine anchors 326, 328, and the lower rear engine anchors 336, 337. The engine 66 housing is strong and rigid and includes mounting points corresponding to each of the six anchors 326, 328, 336, 337, 374, 376. Because the engine 66 is attached to the frame assembly 300 at six different places and the engine 66 housing is rigid, the engine 66, itself, is a structural element of the frame assembly 300. The engine 66 adds strength and rigidity to the frame assembly 300 by providing a structural connection between the front suspension sub-frame 380 and the rear suspension plates 310, 312.

The engine 66, however, need not be incorporated into the frame assembly 300 as a structural member. If an engine 66 is selected that generates vibrations that are best not transferred to the frame assembly 300, it is possible that the engine 66 could be mounted within the frame assembly 300 through vibration dampers, the construction of which are known to those skilled in the art.

The engine 66 is operatively connected to a CVT or other type of transmission, which is mounted to the engine 66. The engine 66 is preferably a four stroke engine, but may alternatively be a two stroke engine. The illustrated engine 66 is a V2 (V-twin) (see FIG. 4) with dual mufflers 546, 548 (see FIG. 3), one being connected to each of the two cylinders of the V2 engine. The engine 66 and CVT are operatively connected to the rear wheel 56 and tire 58.

Left and right foot pegs 550 (see FIGS. 2, 3, 5 and 11) are mounted to foot peg anchor bores 552 in the lower rearward portions of the left and right rear suspension plates 310, 312, respectively.

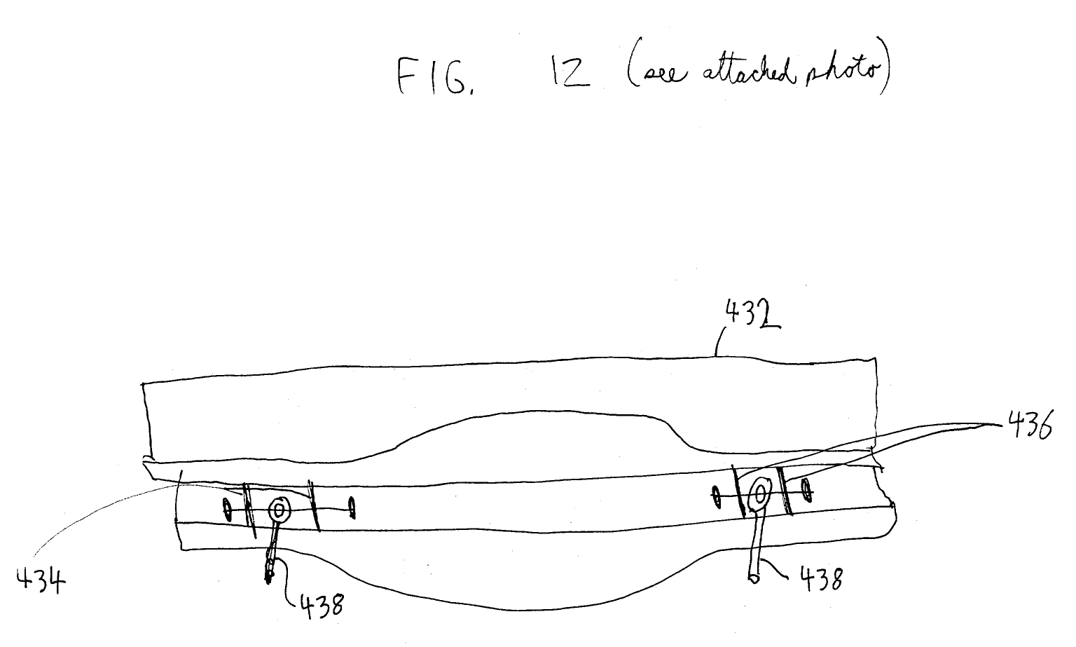

Hereinafter, the front suspension system 600 will be described with specific reference to FIGS. 10 and 14. Left and right lower suspension support arms (or A-arms) 610, 612 are mounted to lower forward and rearward left and right anchors on the V-shaped assembly of the front suspension sub-frame 380 for pivotal movement about generally longitudinally extending lower support arm axes. The bolts 371, 372 (see FIGS. 5 and 14) extend along the lower support arm axes and pivotally mounts the rear ends of the lower support arms 610, 612, to the front suspension sub-frame 380. The bolts 371, 372 therefore clamp together the lower spar bracket 360, the engine cradle plate 370, and the rearward lower support arm anchors.

Left and right upper suspension support arms 616, 618 are mounted to forward and rearward left and right upper anchors on the side panels 382, 383 of the front suspension sub-frame 380 for pivotal movement about generally longitudinally extending upper support arm axes.

A left front wheel knuckle 620 is attached to the outer ends near the apex of the left upper and lower suspension support arms 610, 616 for relative pivotal movement about a generally vertical steering axis. Similarly, a right front wheel knuckle 622 is attached to the outer ends (near the apex of the A shape) of the right upper and lower suspension support arms 612, 618 for relative pivotal movement about a generally vertical steering axis. The left and right front wheels 30, 32 are mounted to the left and right wheel knuckles 620, 622, respectively, for free rotation relative to the wheel knuckles 620, 622 about the respective axes of the wheels 30, 32.

Because the pivotal axes between the frame assembly 300 and the support arms 610, 612, 616, 618 generally extend in the longitudinal direction of the vehicle 10, outer ends of the arms 610, 612, 616, 618 (and consequently the wheels 30, 32) move up and down relative to the frame assembly 300 as the arms pivot about their axes. Consequently, the front suspension system 600 smoothly bears vertical loads exerted between the wheels 30, 32 and the frame assembly 300 of the vehicle 10.

As is known in the art, the wheel knuckles 620 are operatively connected to the steering tie rods 55 (only the left side tie rod 55 is shown) such that pivotal movement of the handlebar 52 turns the wheels 30, 32. As discussed previously, the steering system 50 is preferably a progressive steering system.

Left and right front shock absorbers 630, 632 have upper ends that are pivotally mounted to the left and right shock absorber anchors 396, 398 on the front cross brace 390. Lower ends of the left and right front shock absorbers 630, 632 are pivotally connected to left and right brackets 634, 636 near the outer ends of the left and right lower suspension arms 610, 612.

A sway bar 640 is connected between left and right sway bar brackets 642, 644 on the left and right lower A-arms 610, 612. The sway bar 640 extends laterally through apertures 646, 648 formed between the side panels 382, 383 of the fronts suspension sub-frame 380 and the engine cradle plate 370 (see FIG. 7). The sway bar 640 is mounted to leftward and rightward portions of the engine cradle plate 370 laterally outwardly from the apertures 646, 648. The sway bar 640 links the left and right sides of the suspension system 600 to the frame assembly 300 to dampen swaying/rolling movement of the frame assembly 300.

Front fenders 660, 662 are supported by the wheel knuckles 620, 622 for pivotal steering movement with the wheels 30, 32 during steering.

A split radiator has left and right forwardly-facing portions 670, 672 mounted on opposite lateral sides of the vehicle 10 (see FIGS. 1 and 11). The radiator portions 670, 672 are mounted on anchors 674 that are bolted to the left and right outer ends of the engine cradle plate 370.

As discussed in detail above, the frame assembly 300 primarily comprises tubular members. These tubular members may be hollow extruded members (see, for example, the upper structural braces 486, 488, 492, 494, the lower spars 338, 340, the upper and lower rear engine support cross braces 324, 334, the rear sub-frame 450, and the rear sub-frame braces 460, 462). Alternatively, a tubular member may comprise sheet material that is bent along one or more longitudinal (with respect to the member, not the vehicle) bending lines so as to make it more rigid (see, for example, the front cross brace 390, the longitudinal legs 424, 426, and the rear suspension cross brace 432). The tubular members may even be cast to provide longitudinally extending angled sections that create structural rigidity (see, for example, the upper spars 320, 322 and the rear suspension braces 440, 442). The tubular members are preferably made of a strong light material such as aluminum. The tubular members are therefore both structurally rigid and light. As described above, the many triangles formed throughout the frame assembly 300 provide further rigidity to the frame assembly 300.

The frame assembly 300 is further strengthened by the fact that numerous frame members come together and are connected at various critical points on the frame assembly. For example, the left upper spar 320, left upper column front member 492, front cross brace 390, and the front suspension sub-frame 380 all connect at the connection point 392, which is near where the front left shock absorber 630 connects to the front cross brace 390. Similarly, the left engine cradle leg 338, the lower rear engine support cross brace 334, the left upper spar 320, and the left rear suspension brace 440 all connect together at the left rear suspension plate 310, which is where the rear swing arm 61 pivotally connects to the frame assembly 300.

As a further example, the tank support members 424, 426, the rear suspension braces 440, 442, the upper column rear members 486, 488, and the rear sub-frame 450 all generally connect to the rear suspension cross brace 432 at or near the rearward portion of the tank support members 424, 426. The structural rigidity of this point is critical because the suspension links 63, 64, which transfer the load on the rear wheel 56 to the frame assembly 300, attach to the rear suspension cross brace 432 slightly laterally inwardly from this point.

Various combinations of the above-described frame components may be integrally formed to reduce the number of distinct components that must be assembled to during manufacture of the vehicle 10 or reassembled/replaced during repair of the vehicle 10. For example, in the illustrated embodiment (as best seen in FIG. 5), the rear suspension plates 310, 312 are integrally formed with the upper spars 320, 322, respectively. These integrally formed components could be integrally cast from aluminum (or some other material), welded together, etc.

As illustrated in FIG. 16, the rear suspension braces 440, 442 may also be integrally formed with the rear suspension plates 310, 312, respectively, and upper spars 320, 322, respectively. Consequently, the distinct left rear suspension brace 440, left rear suspension plate 310, and left upper spar 320 could be replaced in the previous embodiment by a left integrally-formed left main frame member 700 that includes a left rear suspension plate portion 702, a left upper spar portion 704, and a left rear suspension brace portion 706. A mirror-image right integrally-formed left rear suspension plate/left upper spar/left rear suspension brace would also be provided. Consequently, the left and right main frame member 700 would be held together in a laterally spaced relationship by the lower rear engine support cross brace 334, the rear upper engine support cross brace 324, the rear suspension cross brace 432, and the front cross brace 390. Additional and/or alternative cross braces may also extend between the main frame members 700 to provide additional strength.

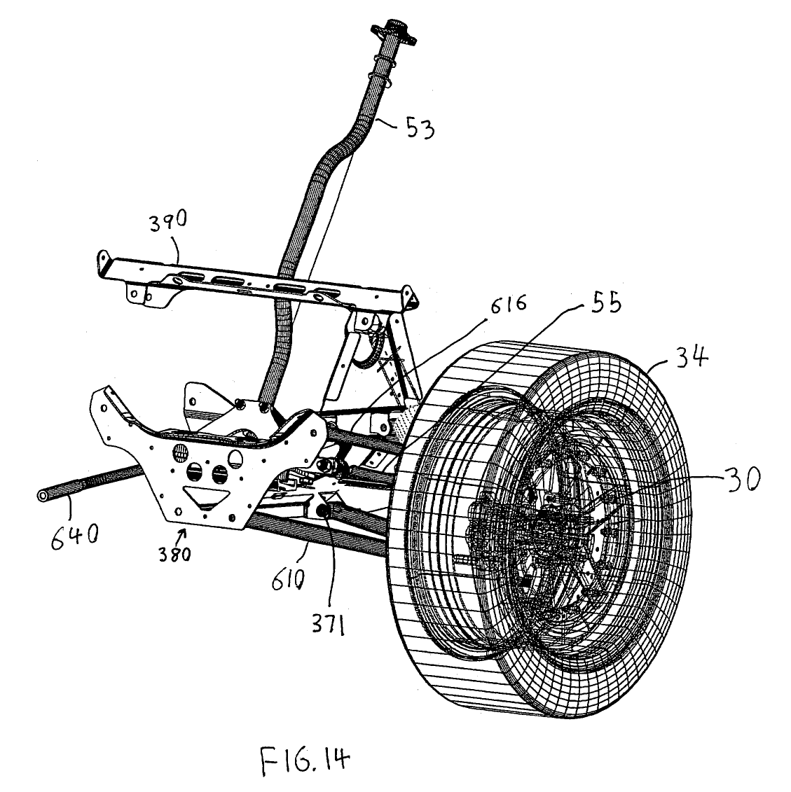

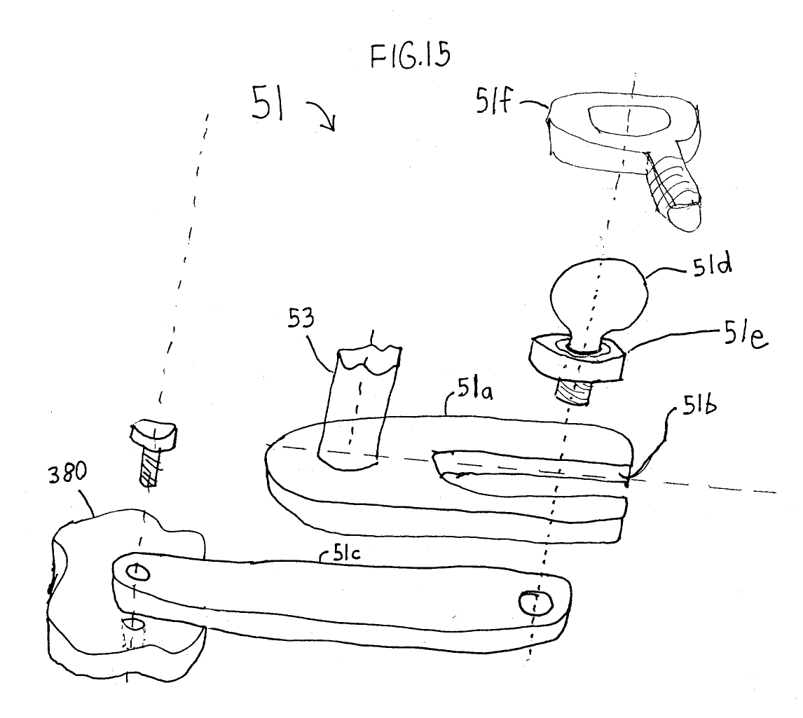

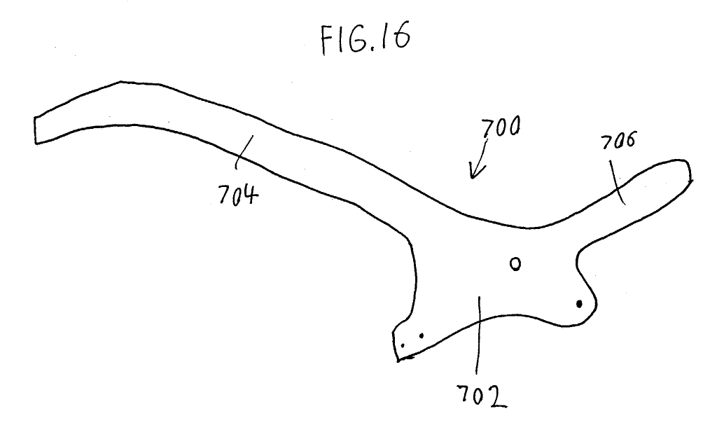

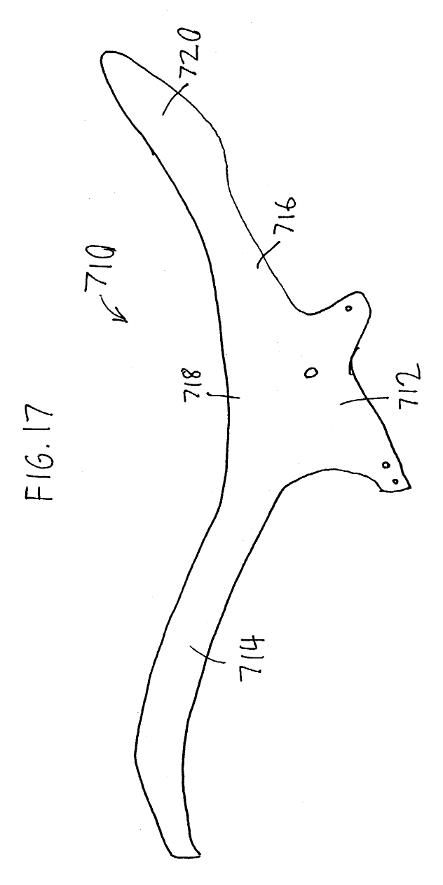

Furthermore, as illustrated in FIG. 17, additional components of the passenger support frame 450 and the rear suspension sub-frame 302 could also be added to the integrally formed left main frame member 700 to form a left main frame member 710. The left main frame member 710 includes an integrally formed left rear suspension plate portion 712, left upper spar portion 714, left rear suspension brace portion 716, left tank support member portion 718, and left side portion 720 of a U-shaped rear sub-frame. A corresponding right main frame member 710 would also be provided. One or more additional cross braces (not shown) may extend between the right and left main frame members 710. One such cross brace may form a middle portion of the U-shaped rear sub-frame defined by the main frame members 710.

The left upper spar portion 714 and left side portion 720 of a U-shaped rear sub-frame may alternatively be formed separately from the remainder of the portions of the left main frame member 710 without departing from the scope of the present invention. Additional frame components may be also added or eliminated from the integrally formed members.

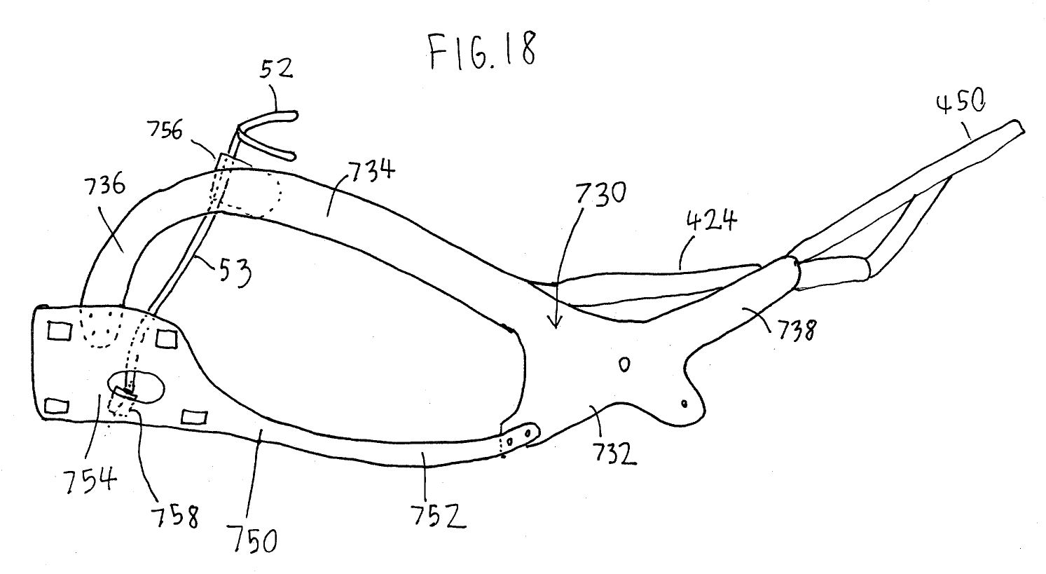

Alternatively, as illustrated in FIG. 18, the upper left portion of the front suspension sub-frame 380 could be incorporated into the left main frame member 700 to form a left main frame member 730 that includes a left rear suspension plate portion 732, a left upper spar portion 734, an upper forward spar portion 736, and a left rear suspension brace portion 738. Appropriately placed cross braces extend between various portions of the right and left main frame members 730.

As illustrated in FIG. 18, the left lower spar 338 and the lower left side of the front suspension sub-frame 380 of the first embodiment may be integrally formed into a left lower frame member 750. The left lower frame member 750 comprises a left lower spar portion 752 and a left front suspension sub-frame portion 754. As in the first embodiment, the left lower spar portion 752 bolts (or is otherwise removably attached) to the left rear suspension plate portion 732 of the left main frame member 730. Similarly, the right lower spar 340 and the right side of the front suspension sub-frame 380 may be integrally formed. The left front suspension sub-frame portion 754 includes anchor points for a front suspension system that are positioned in similar locations to the corresponding anchors in the previously described front suspension sub-frame 380. The left and right front suspension sub-frame portions 754 removably connect to forward portions of the left and right upper forward spar portions 736, respectively, of the main frame members 730. Alternatively, the front suspension sub-frame portions 754 could be integrally formed with the main frame members 730 and be removably connected to the lower frame members 750.

In the embodiment illustrated in FIG. 18, the steering shaft 53 and handlebar 52 are pivotally connected to the left and right lower front suspension sub-frame portions 754 and the left and right upper spar portions 734. An upper steering column bracket 756 extends between the right and left upper spar portions 734 and pivotally connects to the steering shaft 53. Similarly, a lower steering column bracket 758 extends between the right and left lower front suspension sub-frame portions 754 and pivotally connects to the steering shaft 53.

FIGS. 27-30 illustrate an alternative frame assembly 1190, which may replace the frame assembly 300 illustrated in FIGS. 5-7 without departing from the scope of the present invention. Because the frame assembly 1190 is generally similar to the frame assembly 300, a redundant description of each of the similar components is omitted. The frame assembly 1190 includes a bottom plate 1200 that is bolted (or otherwise fastened to) an engine cradle plate 1220 and left and right main frame members 1230, 1240. The bottom plate 1200 includes strengthening bends 1210 along its edges that define left and right spars. Alternative and/or additional spars, such as the spars 338, 340 may be welded, bolted, or otherwise fastened to the bottom plate 1200 to strengthen it. The bottom plate 1200 protects an underside of the engine 66 during operation of the vehicle 10. The bottom plate 1200 may be detached from the frame assembly 1190 in order to provide access to the engine 66 without having to disassemble the frame 1190 components. The bottom plate 1200 may replace the lower spars 338, 340 and the lower spar bracket 360 of the engine cradle assembly 330 of the frame assembly 300 of the embodiment illustrated in FIGS. 5-7 without departing from the scope of the present invention.

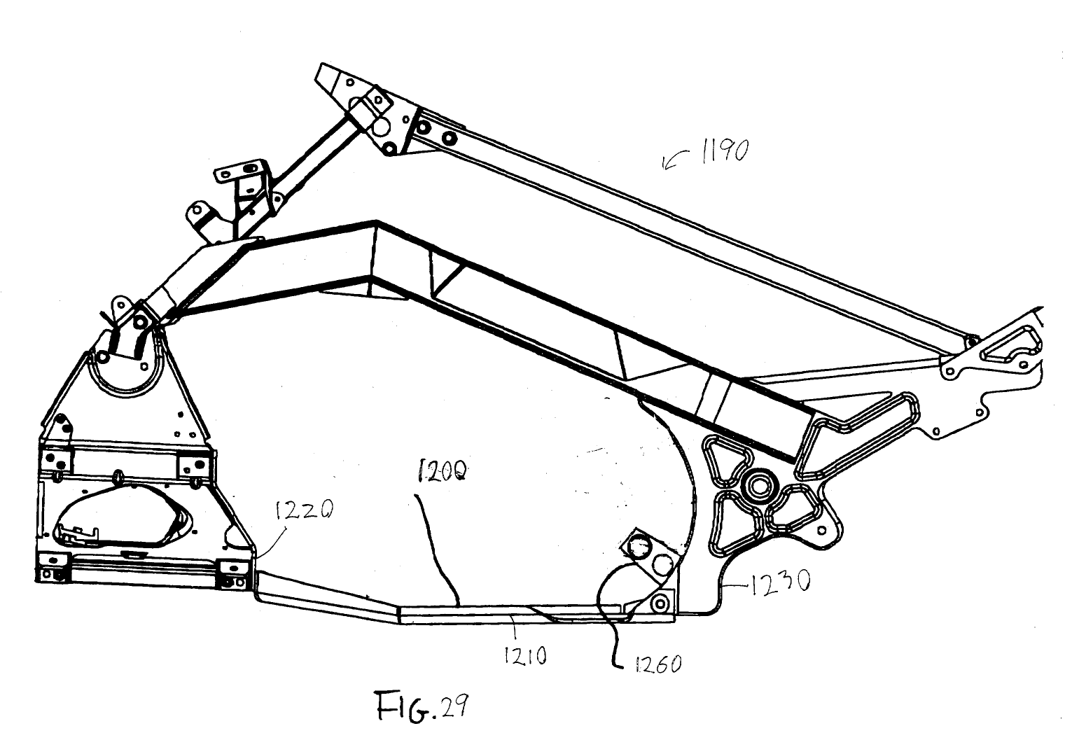

As best illustrated in FIG. 28, the frame assembly 1190 includes a lower engine support cross brace 1250, which extends laterally between the left and right main frame members 1230, 1240. The cross brace 1250 is formed as a tubular member for strength and rigidity and is preferably welded to the main frame members 1230, 1240. As would be appreciated by those skilled in the art, the cross brace 1250 may be affixed to the main frame members 1230, 1240 via any other suitable fasteners or elements.

A single lower rear engine anchor 1260 extends forwardly from the engine support cross brace 1250 and includes engine mounting holes. The lower rear engine anchor 1260 is preferably welded to the engine support cross brace 1250. As would be appreciated by one of ordinary skill in the art, the lower rear engine anchor 1260 may replace the left and right lower rear engine anchors 336, 337 of the frame assembly 300 of the embodiment illustrated in FIGS. 5-7 without departing from the scope of the present invention. An engine, continuously variable transmission, or other part of the vehicle's drive train is mounted, either directly or through intermediate connectors, to the lower rear engine anchor 1260.

While various specific combinations of frame components have been described as integrally formed, the present invention is not limited to just these combinations. Rather, any two or more frame components of the frame assembly 300 may alternatively be integrally formed without departing from the scope of the present invention. Separate integrally formed components/members of the frame are preferably removably attached to each other to simplify their assembly, replacement, and maintenance.

Various components of the frame assembly 300 have been described as being connected using bolts, rivets, welds, integral castings, integral formation, etc. However, as would be appreciated by one of ordinary skill in the art, various other fastening devices and techniques may be used to connect the components of the frame assembly 300 without departing from the scope of the present invention.

In addition to the numerous advantages and features enumerated above, the frame assembly of the present invention may be distinguished from a motorcycle converted into a three-wheeled vehicle for at least one additional reason. FIGS. 24 and 25, which are reproduced from U.S. Pat. No. 5,326,060 are exemplary.

FIG. 24 illustrates a conventional motorcycle 900 with a fuel tank 902, seat 904, rear tire 906, engine 908, and handlebars 910. In FIG. 24, the front tire of the motorcycle 900 has been removed and replaced by a conversion kit 912.

The conversion kit 912 includes a box frame 914 made up of two tubular members in the shapes of triangles connected together via cross-members. The conversion kit 912 attaches to the frame 916 of the motorcycle 900 at the had 918 of the motorcycle 900 and also at a lower portion 920 of the frame 916. As illustrated the frame 914 of the conversion kit 912 has two tires 922, 924 suspended therefrom.

While the conversion kit 912 attaches to the frame 916 at a lower portion 920, importantly, the frame 914 also connects to the frame 916 through the head 918 of the motorcycle 900. The head 918 includes, among other components, a head pipe 926, illustrated in FIG. 25. The head pipe 926 is the cylindrical fitting, usually welded to the frame 916, through which the steering shaft of the handlebars 916 pass to steer the front wheel of the motorcycle 900. The head pipe 926, therefore, is a component of the motorcycle frame 916 that bears the weight of the motorcycle 900 and the rider. In other words, the had pipe 926 acts as a force focal point of the motorcycle frame 916 by bearing the weight of a portion of the motorcycle 900 and the rider. In addition, the head pipe 926 is the point through which the braking force of the motorcycle 900 is channeled. When the front brakes are applied, a portion of the weight of the motorcycle 900, a portion of the weight of the rider, and a portion of the decelerating force on the motorcycle 900 are all channeled through the head pipe 926 to the front tires 922, 924.

One way in which the frame assembly 300 of the present invention differs from the frame 916 and conversion kit 912 of the prior art is in the fact that the frame assembly 300 is not a kit 912 designed to modify a motorcycle 900 to include two front wheels 922, 924. One way to define the frame assembly 300 is to examine the basic elements that distinguish the frame assembly 300 from the frame conversion kit 912.

The frame assembly 300 differs from the conversion kit 912 by the simple fact that the frame assembly 300 is not a conversion kit. The frame assembly 300 is an entirely new frame specifically designed to withstand the forces encountered by a three-wheeled vehicle during high-performance road operation.

The frame assembly 300 also differs from the frame conversion kit 912 by the fact that the frame assembly 300 does not include a head pipe 926 or any other structure through which weight or braking forces are channeled to any other portion of the frame assembly 300. The mere fact that the frame assembly 300 does not rely on the head pipe 926 as a force focal point distinguishes the frame assembly 300 from the prior art. In addition, the fact that the frame assembly 300 does not relay on a head pipe 926 and a force focal point means that the forces acting on and generated by the vehicle 10 are more evenly distributed over the various frame components. As a result, handling characteristics for the vehicle 10 are greatly enhanced.

For ease of reference, the frame assembly 300 will also be referred to as a head pipeless frame or as a frame lacking a force focal point.

The foregoing illustrated embodiments are provided to illustrate the structural and functional principles of the present invention and are not intended to be limiting. To the contrary, the principles of the present invention are intended to encompass any and all changes, alterations and/or substitutions within the spirit and scope of the following claims.

What is claimed is:

1. A three-wheel vehicle comprising:
a frame assembly comprising
left and right laterally spaced rear suspension plates,
left and right laterally spaced upper spars extending forwardly and upwardly from the left and right rear suspension plates, respectively,
left and right lower spars extending forwardly from the left and right rear suspension plates, respectively, and
a front suspension sub-frame with a rearward portion that connects to forward ends of the lower spars;
an engine supported by the frame assembly;
a pair of front wheels supported by the front suspension sub-frame;
a single rear wheel supported by the frame assembly, the rear wheel being operatively connected to the engine such that the engine drives the rear wheel; and
a straddle seat supported by the frame disposed between the front wheels and the rear wheel.

2. A vehicle according to claim 1, wherein the front suspension sub-frame has left and right upwardly extending portions that are connected to forward ends of the left and right upper spars, respectively.

3. A vehicle according to claim 1, wherein the frame assembly further comprises:
a lower spar bracket connected to the forward ends of the lower spars and to the front suspension sub-frame, the forward ends of the lower spars being connected together via their mutual connection to the lower spar bracket.

4. A vehicle according to claim 3, wherein the lower spar bracket and the lower spars are integrally formed and are removably connected to the front suspension sub-frame and the rear suspension plates.

5. A vehicle according to claim 4, wherein the lower spar bracket and the lower spars comprise a bent sheet of metal.

6. A vehicle according to claim 1, wherein the frame assembly further comprises:
an engine cradle plate connecting the lower spars to the front suspension sub-frame, the engine cradle plate extending laterally and vertically and including at least one bend along a laterally-oriented fold line.

7. A vehicle according to claim 6, wherein the frame assembly further comprises left and right laterally spaced forward engine anchors connected to the engine cradle plate,
wherein the engine is mounted to the left and right laterally spaced forward engine anchors.

8. A vehicle according to claim 1, wherein the lower spars comprise tubular members.

9. A vehicle according to claim 1, wherein the lower spars extend laterally inwardly toward each other as they progress forwardly.

10. A vehicle according to claim 9, wherein the frame assembly further comprises:
a laterally-extending lower rear engine cross brace connected between forward lower portions of the rear suspension plates,
wherein the lower rear engine cross brace and the lower spars generally form a triangle when viewed from above.

11. A vehicle according to claim 10, wherein the lower rear engine cross brace comprises a tubular member.

12. A vehicle according to claim 10, wherein:
the frame assembly further comprises a lower rear engine anchor attached to the lower rear engine cross brace; and
the engine is mounted to the lower rear engine anchor.

13. A vehicle according to claim 10, wherein the frame assembly further comprises:
left and right laterally spaced lower rear engine anchors attached to the lower rear engine cross brace,
wherein the engine is mounted to the left and right engine anchors.

14. A vehicle according to claim 13, the frame assembly further comprises:
an upper rear engine support cross brace connected between forward upper portions of the left and right rear suspension plates;
left and right laterally-spaced upper rear engine anchors connected to the upper rear cross brace and to the engine; and
left and right laterally spaced forward engine anchors connected to the front suspension sub-frame and the engine,
wherein the engine adds rigidity to the frame assembly by way of its simultaneous connection to the upper rear engine support cross brace, the front suspension sub-frame, and the lower rear engine cross brace.

15. A vehicle according to claim 1, wherein the rearward ends of the left and right lower spars are removably connected to the left and right rear suspension plates, respectively, and
wherein the forward ends of the lower spars are removably connected to the front suspension sub-frame, and
wherein the left and right lower spars, when removed from the frame assembly, enable access to the engine.

16. A vehicle according to claim 1, wherein the frame assembly further comprises:
left and right rear suspension braces connected to upper rearward portions of the left and right rear suspension plates, respectively.

17. A vehicle according to claim 16, wherein the left and right rear suspension braces, respectively, are integrally formed with the left and right rear suspension plates, respectively.

18. A vehicle according to claim 16, wherein the front suspension sub-frame has left and right upwardly extending portions, and wherein the frame assembly further comprises:
a pyramid-shaped upper structural support assembly comprising:
a left upper column rear member extending forwardly and upwardly from a rearward portion of the left suspension brace to an apex,
a right upper column rear member extending forwardly and upwardly from a rearward portion of the right suspension brace to the apex,
a left upper column front member extending upwardly and rearwardly from the left upwardly extending portion of the front suspension sub-frame to the apex, and
a right upper column front member extending upwardly and rearwardly from the right upwardly extending portion of the front suspension sub-frame to the apex.

19. A vehicle according to claim 18, wherein the left and right front and upper column rear members comprise tubular members.

20. A vehicle according to claim 18, wherein the pyramid-shaped upper structural support assembly further comprises a steering column bracket connected to upper ends of the front and rear left and right braces, the steering column bracket defining the apex.

21. A vehicle according to claim 16, wherein the rear suspension braces extend upwardly and rearwardly from the rear suspension plates.

22. A vehicle according to claim 21, wherein the frame assembly further comprises:
a rear suspension cross brace connected between rearward portions of the left and right suspension braces.

23. A vehicle according to claim 21, wherein the frame assembly further comprises:
a left tank support member connected to the left rear suspension plate;
a right tank support member connected to the right rear suspension plate; and
a rear suspension cross brace connected between rearward portions of the left and right tank support members.

24. A vehicle according to claim 23, wherein the left and right tank support members, respectively, are integrally formed with the left and right rear suspension plates, respectively.

25. A vehicle according to claim 24, wherein the left and right rear suspension braces, respectively, are integrally formed with the left and right rear suspension plates, respectively.

26. A vehicle according to claim 23, wherein forward portions of the left and right tank support members are connected indirectly to upper forward portions of the left and right rear suspension plates, respectively, by way of a connection between the forward portions of the left and right tank support members to rearward portions of the left and right upper spars, respectively.

27. A vehicle according to claim 16, wherein the frame assembly further comprises:
a generally U-shaped rear sub-frame having ends connected to the rearward portions of the left and right rear suspension braces.

28. A vehicle according to claim 27, wherein the rear sub-frame includes left and right portions, and wherein the left portion of the rear sub-frame, the left rear suspension brace, and the left rear suspension plate are integrally formed, and wherein the right portion of the rear sub-frame, the right rear suspension brace, and the right rear suspension plate are integrally formed.

29. A vehicle according to claim 27, wherein the rear sub-frame comprises a tubular member.

30. A vehicle according to claim 27, wherein the frame assembly further comprises:
a left tank support member connected to the left rear suspension plate;
a right tank support member connected to the right rear suspension plate;
a left rear sub-frame brace connected between a rear end of the left tank support member and an intermediate portion of the rear sub-frame; and
a right rear sub-frame brace connected between a rear end of the right tank support member and an intermediate portion of the rear sub-frame,
wherein the rear sub-frame braces, the tank support members, and the rear sub-frame generally form triangles when viewed from the side.

31. A vehicle according to claim 30, wherein the rear sub-frame braces comprise tubular members.

32. A vehicle according to claim 1, further comprising an upper rear engine support cross brace connected between forward upper portions of the left and right rear suspension plates.

33. A vehicle according to claim 32, wherein the upper rear engine support cross brace is connected indirectly to upper forward portions of the left and right rear suspension plates, respectively, by way of a connection between the upper rear engine support cross brace to rearward portions of the left and right upper spars, respectively.

34. A vehicle according to claim 32, wherein the upper rear engine support cross brace comprises a tubular member.

35. A vehicle according to claim 32, wherein the frame assembly further comprises left and right laterally-spaced upper rear engine anchors connected to the upper rear cross brace.

36. A vehicle according to claim 1, wherein the left and right upper spars, respectively, are integrally formed with the left and right rear suspension plates, respectively.

37. A vehicle according to claim 36, wherein the frame assembly further comprises:
a rear suspension swing arm pivotally connected to the left and right rear suspension plates and supporting the rear wheel.

38. A vehicle according to claim 1, wherein the front suspension sub-frame comprises left and right portions that are removably connected together, the left and right upper spars removably connect to the left and right portions, respectively, of the front suspension sub-frame, the left front suspension sub-frame portion and the left lower spar are integrally formed, and the right front suspension sub-frame portion and the right lower spar are integrally formed.

39. A vehicle according to claim 1, further comprising:
a handlebar; and
a progressive steering system operatively connecting the handlebar to the front wheels to steer the vehicle.

40. A vehicle according to claim 39, wherein a steering angle of the front wheels increases progressively more and more per degree of handlebar rotation as the front wheels approach a maximum steering angle.

41. A vehicle according to claim 40, wherein the handlebar cannot pivot more than 30 degrees to either side of its straight forward position, and the front wheels can pivot more than 40 degrees to either side of their straight forward position.

42. A three-wheel vehicle comprising:
a frame assembly comprising
left and right main frame members, each of which comprises
a rear suspension plate portion, and
a longitudinally-elongated upper spar portion formed integrally with the rear suspension plate portion and extending forwardly and upwardly from the rear suspension plate portion;
left and right lower frame members, each of which comprise a longitudinally elongated lower spar portion, rearward ends of the left and right lower frame members being removably connected to the left and right rear suspension plate portions of the left and right main frame members, respectively;
left and right front suspension sub-frame portions connected to the left and right upper spar portions, respectively, and connected to the left and right lower spar portions, respectively;
an engine supported by the frame assembly and disposed between the upper and lower spar portions as viewed from the side;
a pair of front wheels supported by the front suspension sub-frame portions;
a single rear wheel supported by the left and right rear suspension plate portions, the rear wheel being operatively connected to the engine such that the engine drives the rear wheel; and
a straddle seat supported by the frame disposed between the front wheels and the rear wheel.

43. A vehicle according to claim 42, wherein the left and right front suspension sub-frame portions, respectively, are integrally formed with the left and right lower frame members, respectively.

44. A vehicle according to claim 43, wherein the removable connections between the left and right front suspension sub-frame portions, respectively, and the left and right upper spar portions, respectively, comprises bolts, and wherein the removable connection between the left and right lower frame members, respectively, and the left and right rear suspension plate portions, respectively, comprises bolts.

45. A vehicle according to claim 42, wherein the front suspension sub-frame has left and right upwardly extending portions that are connected to forward ends of the left and right upper spar portions, respectively.

46. A vehicle according to claim 42, further comprising:
a steering shaft pivotally connected to at least one of the main frame members and at least one of the front suspension sub-frame portions; and
a handlebar connected to the steering shaft,
wherein the steering shaft is operatively connected to the front wheels such that pivotal movement of the steering shaft steers the front wheels.
